(19) United States
(12) Patent Application Publication
(10) Pub. No.: US 2015/0127567 A1
(43) Pub. Date: May 7, 2015

(54) DATA MINING INCLUDING PROCESSING NATURAL LANGUAGE TEXT TO INFER COMPETENCIES

(71) Applicant: UV Labs, Inc., San Francisco, CA (US)

(72) Inventors: Satish Menon, Sunnyvale, CA (US); Tomi Jussi Blinnikka, San Pablo, CA (US); Jayakumar Muthukumarasamy, Dublin, CA (US); Joseph Deck, Monrovia, CA (US); Byron Edward Dom, Los Gatos, CA (US); Jeyendran Balakrishnan, Los Gatos, CA (US)

(21) Appl. No.: 14/314,028

(22) Filed: Jun. 25, 2014

Related U.S. Application Data
(60) Provisional application No. 61/898,867, filed on Nov. 1, 2013.

(51) Int. Cl. G06F 17/27; G06Q 10/10

(52) U.S. Cl. CPC G06F 17/27; G06Q 10/1053
USPC 705/321

(57) ABSTRACT

A data mining system extracts job opening information and derives, for a given job, relevant competencies and derives, for a given candidate, relevant competencies, for the candidate. In some embodiments, the data mining performs authentication of relevant competencies before performing matching. The matching outputs can be used to provide data to a candidate indicating possible future competencies to obtain, to provide data to a teaching organization indicating possible future competencies to cover in their coursework, and to provide data to employers related to what those teaching organizations are covering.

### FIELD OF THE INVENTION

The present invention relates generally to data mining and more particularly to processing natural language text provided about job candidates to derive inferred competency ratings of the job candidates.

### BACKGROUND OF THE INVENTION

With millions of job openings and tens of millions of unemployed or underemployed workers, the problem of fuller employment might not be that there are not enough jobs, but the problem might be the difficulty of matching a job candidate to an open job position.

Before the use of computers in business, matching was typically done by candidates submitting résumés, having each prospective employer independently screen the résumés to filter down to a smaller subset of candidates, extensively interview and test the finalists and then make an offer. With the insertion of computers in business, some aspects of the hiring process have changed, but others have not.

For example, a candidate can now easily submit a résumé to hundreds or thousands of employers, using computers and automation. Of course, that means that if every candidate takes this approach, each employer would see hundreds or thousands of résumés for each position, even if the number of candidates were about the same as the number of open positions. Employers, who cannot feasibly interview thousands of candidates for each open position, might then resort to automated filtering of incoming résumés, perhaps using keywords to pass or block résumés for further processing.

In response, some candidates have resorted to “résuméspamming” wherein a candidate adds irrelevant keywords to their résumé to ensure that their résumé passes the automated filter. Naturally, if the candidate does not actually possess the abilities that the employer expects given the keywords used, the candidate will fail at the interview process, wasting time and money of the employer and the candidate, or will be able to sneak into the job only later to have their inabilities exposed, at much cost to all parties.

These situations are, in part, created by the fact that some aspects of the job matching process are automated, while others are attempted manually. Often, those other steps are performed manually with everyone aware of their shortcomings, because the matching relies on unstructured processes and manually comparing candidates to open jobs appeared to be the only way to do it.

An improved method and apparatus for data mining candidate data and employer data is needed to perform job matching at a scale reflective of the amount of time and energy spent on recruiting and hiring using tools of the past.

### SUMMARY OF THE INVENTION

A data mining system extracts job opening information, derives, for a given job, relevant competencies, and derives, for a given candidate, relevant competencies, or the candidate. In some embodiments, the data mining performs authentication of relevant competencies and levels before performing matching.

The matching outputs can be used to provide data to a candidate indicating possible future competencies to obtain, to provide data to a teaching organization indicating possible future competencies to cover in their coursework, and to provide data to employers related to what those teaching organizations are covering.

In a specific embodiment, job description data from an employer recruitment database is extracted and processed into competency data, wherein competency data identifies nodes of a competency taxonomy and levels of competency needed for each node considered. In such an embodiment, skill sets from candidates are extracted from résumé data and/or other inputs from candidates.

The candidate competencies (and their level of competency) can be obtained by inference—from the statement, “Candidate attended medical school at school X” competency at first aid can be inferred. Candidate competencies (and their level of competency) can also be obtained by employer-initiated and/or employer-independent testing or other methods and processes.

The following detailed description together with the accompanying drawings will provide a better understanding of the nature and advantages of the present invention.

### BRIEF DESCRIPTION OF THE DRAWINGS

Various embodiments in accordance with the present disclosure will be described with reference to the drawings, in which:

FIG. 1 is an illustrative example of an environment according to prior art;

FIG. 2 is an illustrative example of an environment according to prior art;

FIG. 3 is an illustrative example of a block diagram in accordance with at least one embodiment;

FIG. 4 is an illustrative example of a block diagram in accordance with at least one embodiment;

FIG. 5 is an illustrative example of a block diagram in accordance with at least one embodiment;

FIG. 6 is an illustrative example of a module in accordance with at least one embodiment;

FIG. 7 is an illustrative example of an environment in accordance with at least one embodiment;

FIG. 8 is an illustrative example of a process in accordance with at least one embodiment;

FIG. 9 is an illustrative example of a block diagram in accordance with at least one embodiment;

FIG. 10 is an illustrative example of a block diagram in accordance with at least one embodiment; and

FIG. 11 is an illustrative example of interconnected computer systems according to at least one embodiment.

Appendices A1, A2, B1, and B2 provide examples of inputs (A1, B1) and their corresponding outputs (A2, B2).

### DETAILED DESCRIPTION OF THE INVENTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Techniques described and suggested herein include automatically extracting information from documents by understanding the structure of a sentence. By understanding the structure of a sentence, the system is able to extract the skill terms as well as how these skill terms are being used in a job. Example embodiments may distinguish primary skills from subordinate skills as well as understand the level of proficiency required for any given skill. Such information will help identify new skills as they become popular as well as compare the competencies in documents at a level that has never been possible before.

Extracting competencies from job descriptions, résumés, and course descriptions is important to understand the skills required by a job, the skills offered by a person and the skills taught by a course. The information in these documents is typically in an unstructured form and is intended for human consumption. Extracting this information in a structured form using algorithms enables the system to automate the comparison between different documents. For example, by extracting the information in a résumé and a job description one can determine the relevance of a résumé to the job. Similarly, by extracting information in a course description one can compare the competencies required by a job with one course or a set of courses. Finally, extracting information from jobs helps the system to understand common skills across occupations.

Existing methods to extract skills from a job description automatically use a curated dictionary of skills to guide the extraction and have limitations. Curating a valid dictionary of skills is expensive and limiting. For example, as the market requires new skills, the dictionary needs to be constantly updated in order to stay relevant. Such approaches do not consider context and can therefore extract inappropriate skills as being appropriate. For example, the job description of an accounting job at Intel® will include information about Intel and its primary business, which is semiconductor. A keyword-based extraction may extract “semiconductor” as a skill required by the job when the job may not require such a skill. This approach focuses on extracting just the skill terms but not on how those skills are being applied. For example, a quality assurance (QA) job description in a software development team and a software developer's job description will both contain the similar skills such as .Net, Java, J2EE, etc. While, a QA developer may only be required to understand these skills at a superficial level a developer will need to understand these skills at a much deeper level.

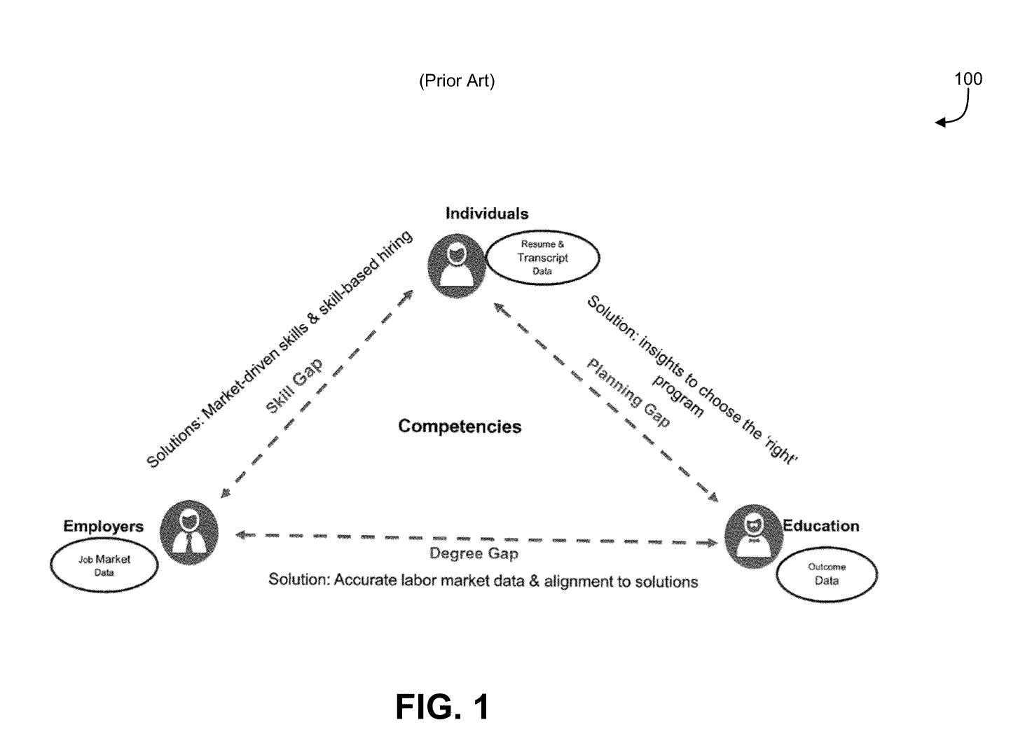

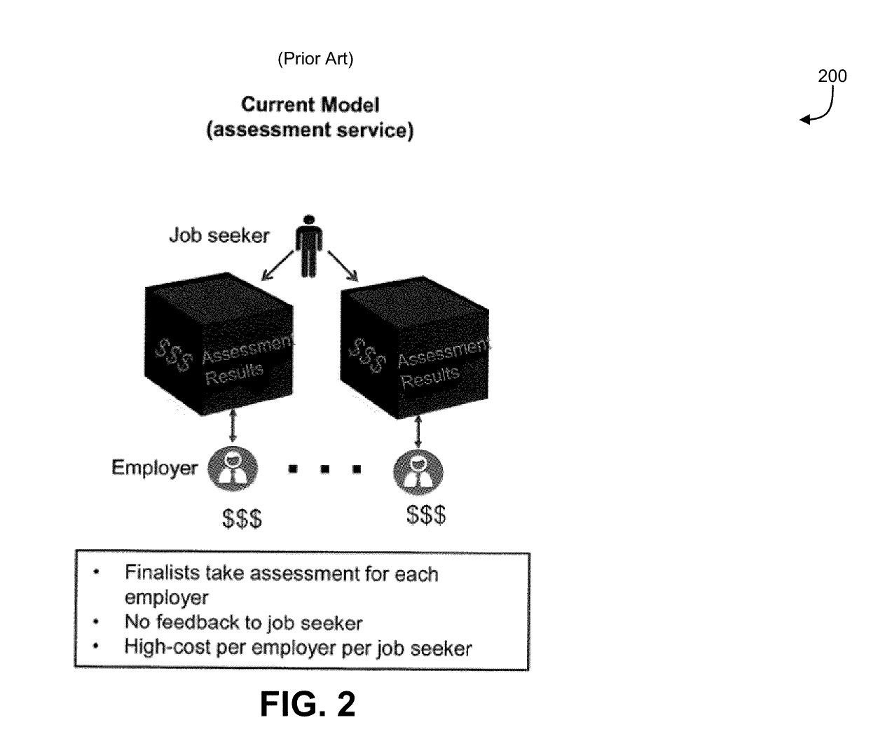

FIGS. 1 and 2 are examples of a prior art environment 100; more specifically, FIG. 1 shows the education to workforce ecosystem composed of individuals (representing “talent”), employers (representing “labor market”) and education/training (representing “solutions”) and FIG. 2 shows a current model for assessment services.

The lack of linkage between ecosystem “players” creates imperfect information, which may then lead to significant inefficiencies and gaps. The “degree gap” is where the output of the education system is not aligned with the needs of the labor market; the “planning gap” is where individuals do not have adequate information about the state of the labor market before they embark on programs of study; and the “skill gap” is where individuals do not have the skills required to fill open jobs due to lack of clear understanding on what the employer needs are and their own capability gaps and lack a clear path to addressing them. In some embodiments, the candidate competencies (and their level of competency) may increase, by training or other methods.

In some embodiments, labor market information systems are supplied with data to describe current and future (projected) labor market needs. Educational institutions may take advantage of such a labor market information system to design/redesign programs and create the outcomes the labor market and the consumers they serve are looking for. Likewise, students may select education/training programs, clearly understanding what the labor market needs are (vis-à-vis their career goals), and the most efficient/cost-effective pathway to achieving them.

Job seekers (“candidates”) will be able to understand what the skill requirements are for the jobs they are interested in and where necessary, have tools available to validate their skills or understand where the gaps are. Job seekers will be able to find effective solutions to close any gaps in their skill profiles.

Individuals not necessarily looking for work will be able to understand whether their current skills are becoming obsolete and take action to skill-up and remain relevant in the job market. Experts will be able to understand what the gaps in education/training are vis-à-vis the labor market and create content (programs) to address them.

Turning to FIG. 2, typical assessment models create a test output for an employer, which belongs to the employer, seldom seen by the test taker and seldom reused. The model also costs more for the employer. In the data-mining model, the assessment is delivered from the platform, the test taker owns their own data, and the output is a validated skill profile that is reused across their job search, resulting in lower cost of acquiring profiles by the employer. In addition, pre-existing assessments may be used to create an initial profile.

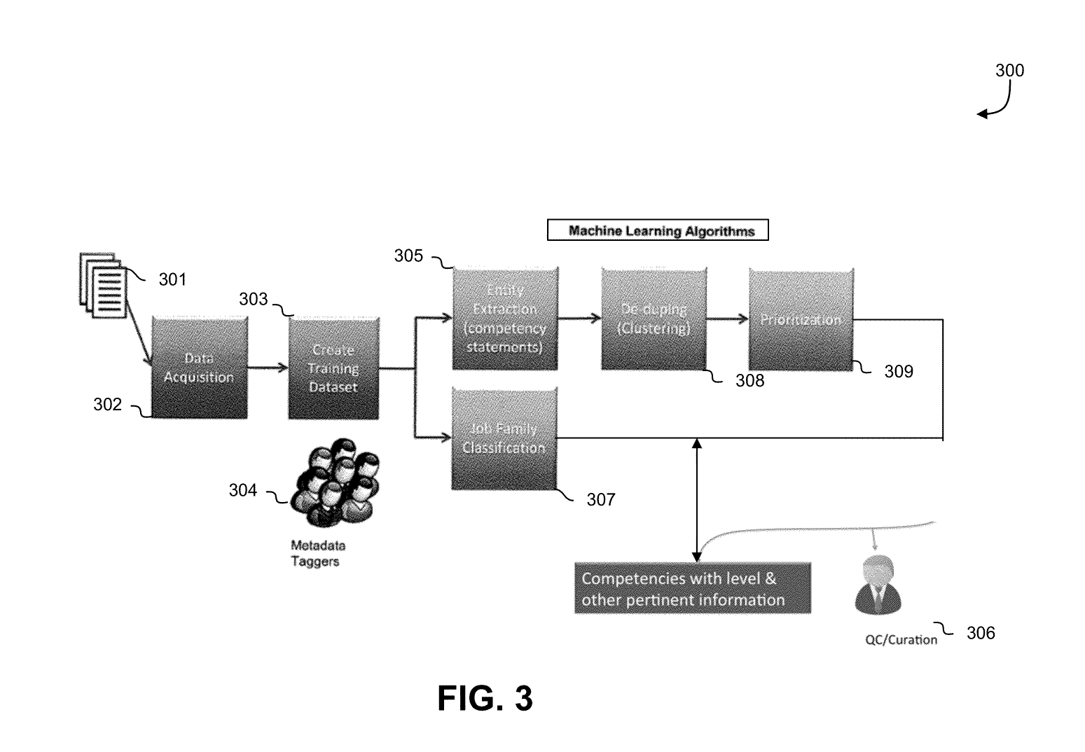

FIG. 3 depicts a method and apparatus for extracting entities 300 from input documents.

An example embodiment of an extraction process consists of a training process in which the algorithm “learns” the patterns for extracting competencies from job descriptions and an extraction process in which the algorithm uses the learned patterns to extract competencies from unseen job descriptions.

The data extraction process starts with annotating a number of existing job postings and other documents 301. These may be standard job postings posted to company websites, job boards and other online destinations. The data acquisition stage 302 processes these job postings, strips any extraneous content such as advertisements and company specific branding information and makes the scraped job description available for further processing by the data extraction process. A subset of these job descriptions is presented to annotators for manual annotation. The data produced by the manual annotation process is then used to train entity extraction software to extract job requirements and competency information automatically from untrained job postings.

The result of this extraction process is a set of leveled competencies described in a structured manner for a single job description. The next two stages in the pipeline deal with classifying job descriptions into occupations and using the set of occupations to prioritize competencies and competency levels at an occupation level. The classification of jobs to occupations may be performed in one of two ways—classification approach 307 where annotators manually create training sets 303 for each occupation and train a machine learning classifier (such as a Maximum Entropy classifier) to classify unseen job descriptions or using clustering approaches 308 (such as K-Means, Latent Dirichlet Allocation or Latent Semantic Analysis) to group occupations with similar competencies together to create a model. Using the clustering approaches to prioritize competencies 309 and competency levels at an occupation level. A combinational approach is also possible where jobs could be classified to a standard taxonomy such as the Bureau of Labor Statistics (BLS) taxonomy or O*Net using manually labeled data and then using clustering approaches within an occupation to segment an occupation further based on competencies. An advantage of using a standard taxonomy is that the rest of the labor market data (such as the BLS data) could be connected more easily to competency information making the information all the more useful.

In alternative example embodiments, as shown, a known set of data and entities might be provided to train the system on the process. Appendices A1 and A2 illustrate two examples of input document text that might be input and corresponding examples of what competency statements and other entity data structures might be generated as a result of extraction from those inputs.

In the first example, shown in Appendix A1, the inputs include unstructured text relating to primary responsibilities and requirements for a position. The outputs in Appendix A1 are data structures encapsulating extracted competency records that were machine-generated from the job description. Note that this is just an example and a job might entail additional competencies not shown here. The output data is illustrated in Appendix A1 in JSON format, but other formats might be used instead.

Note that each competency is leveled using a taxonomy. The leveling taxonomy in this example uses knowledge levels of Bloom's taxonomy (Remember, Understand, Apply, Analyze, Evaluate and Create) and augments it to include capabilities such as Collaboration, Coordination and related Operational aspects, Lead/Manage, and Mentoring. Other types of taxonomy mappings are also possible.

Each competency is also assigned a weight that defines the importance or relevance of this competency to the given job. Where possible, the competency is also connected to its equivalent definition in an external knowledge source, so that all parties may work from the same definitions. The external knowledge source is typically a taxonomy of knowledge and/or skills. While competencies are connected to external taxonomies where possible, the external taxonomy is not necessary for the competency to be extracted. The competency may be extracted independent of the taxonomy and then linked where possible.

The overall computer system may be treated as a framework that allows importing of “signals” about competencies (perhaps weighted as described above) a candidate has. Résumés, school transcripts, etc. are just examples of signals. Others may include interaction on social networks, open sourced software or contributions, participation in a community (online or offline), performance reviews, publications, code check-ins, etc.

A second example is shown in Appendix A2, with the inputs provided to a competency extraction engine that inputs the unstructured text relating to a job description, Essential Duties and Responsibilities listing, and a Desired Skills and Experience listing.

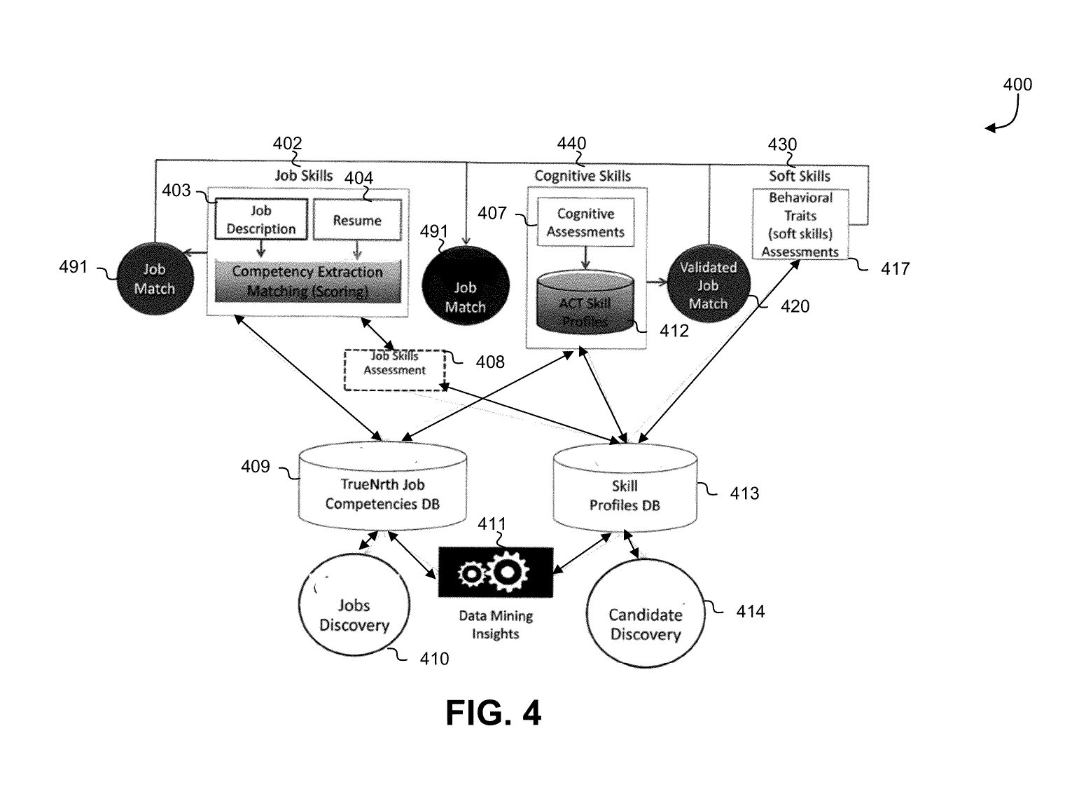

FIG. 4 is an illustrative example of an environment 400 showing two databases created by extracting and aligning competencies according to example embodiments. FIG. 4 depicts two of the databases, system inputs (such as résumés 401 and job descriptions 403), processing steps (such as competency extraction 404 using automated processing such as machine learning and/or human manipulation of data), and normalized outputs stored in the databases.

Validation Of Competencies

Employers need to hire the “right candidate” and individuals need to understand their current capabilities (so they may plan path to the goal efficiently), assessing skills are required. Traditionally, assessments are seen as filters to keep people out; our concept is to use assessments as a way of guiding people in. To achieve this, the steps include the following:

Making assessments easy to take and provide clear value proposition to the assessment takers, validated skill profiles for employers, understanding gaps, and providing connections to solutions;

Assessments need only be done once and reused during applicants' job search process;

Mapping assessments, such as cognitive assessments 407 for cognitive skills 440, to job skills 402 required (rather than providing generic multi-hour assessments) in order to enhance and provide job matching 401;

Enabling assessments to be taken anytime/anywhere so that individuals will use them as a guide to understanding current skill profile 412 and measuring advancement towards goal. Assessment may also happen offline (in physical locations) which is the traditional approach used today; and

Making assessment delivery secure and prevent cheating.

With such example embodiments, a host of applications may be built to address the planning gap, skill gaps and degree gaps. Using data sciences and assessments as foundation, the data mining system 411 may operate an education-to-career place connecting individuals, employers, and education solutions; all built on top of the competency databases 409.

For the employers, reducing the cost of buying validated skill profiles so that they may do away with résuméspamming or losing good candidates. According to example embodiments presented herein, the task of assessing a candidate is performed by the system provider, rather than separately for each employer. With this strategy, candidates may reuse assessments across other employers. Additionally, the act of sharing the assessment across many employers reduce the cost of assessments for each employer and enable them to buy validated skill profiles across their entire applicant pool, thereby reducing or eliminating the side effects of résuméspamming and losing good candidates. Candidates skill profiles 412 may be maintained in a skill profile database 413 for use by one or more employers, recruiters, and the like in order to maintain information about all candidates for current and future use.

Candidates' competencies may be assigned a validity measure, which might range from a value representing an un-validated competency to a value representing a validated competency. One method of assigning validity measures is to store, in a data record or the like, values of graduated weights with each (or some) competency reported by the individual. The system might also have a weighting module comprising programming, logic, etc. for calculating a graduated weight for a particular competency given certain inputs.

For example, suppose a candidate reports that they have a competency in building financial models, and the candidate is a new graduate with little work experience. The weighting module might be programmed to assign a weight of 2 (in a graduated scale of 0 to 10) for that competency for that candidate, whereas the weighting module might be programmed to assign to another candidate who has work experience on financial modeling a weight of 6. Both candidates may use assessments as a way of advancing their overall score, based on performance of an assessment. If a suitable assessment is not available, the weight system may be used as a proxy of the level that the candidate is at, for particular competencies. The weighting module may use any “signal” (for example, a review or attestation by a supervisor or a peer/colleague) to advance (or reduce, if warranted) the weight associated with a competency. Additionally, weights may be reduced over time (or using some other criteria) as skills may decay due to non-use or other criteria. Users may renew, refresh, or revalidate as necessary.

Technology Strategy

Example embodiments may include technology strategy mechanisms including large system components, such as, for example: systems that may gather competencies from various sources (job descriptions, résumés, assessment outcomes, etc.) and normalize (using taxonomies) to build the databases and associated services described in the solution strategy; large-scale creation validation instruments necessary to validate skill profiles containing all elements of competencies: cognitive abilities and/or skills, job skills assessments 408, behavioral traits (417), and other critical data points that employers deem necessary to measure potential for job performance Particular focus is on assessment delivery online, with the test security concerns addressed; and a feedback system providing a marketplace for solutions that enable an individual to acquire the competencies they need in a cost/time efficient manner.

A jobs discovery database 410 that contains current job openings indexed by the competencies (and level) required by the employers.

A candidate discovery database 414 that contains validated skill profiles of candidates.

A solutions discovery database that contains content (or metadata about content) that describes assessments for validating competencies, training or educational content mapped to competencies and enables and helps with candidate discovery 414.

An analytics database that contains information gleaned from the operation of the system: for example, efficacy of a certain solution's ability to address the gaps for a certain profile of users.

These databases, combined with specific business logic and algorithms, enable a number of services to address skill-gap, program gap, and degree gaps outlined before. In some embodiments, these databases are technically and/or physically separate, but in other embodiments, they are more integrated. The databases could be implemented using a standard database management system (DMBS) and other add-ons, relational databases, or other type of a data store with capabilities of creating, updating, querying and browsing data.

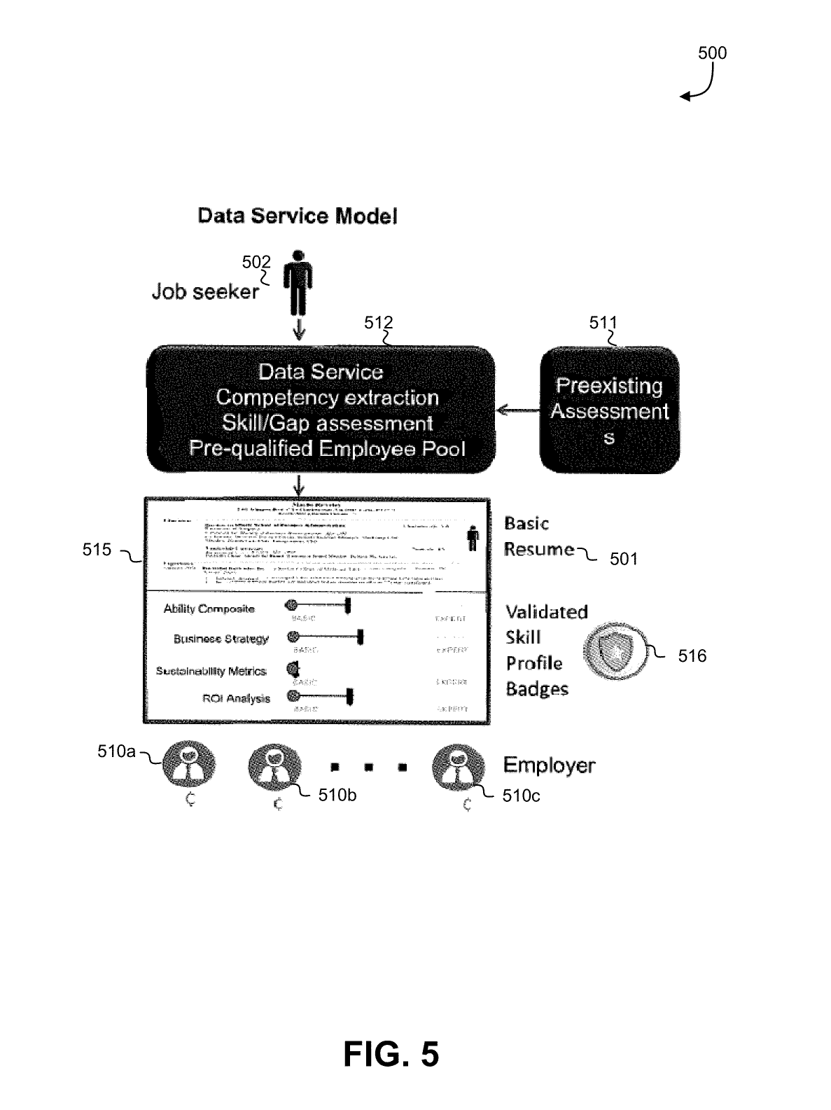

FIG. 5 is an illustrative example of a data service model 500 in accordance with example embodiments presented herein.

Labor Market Information System

In order to provide tools for educators to build effective programs, guidance system for individuals to choose their career (and the changing career landscape), there is a need for a dynamic labor market information system that provides a pulse of employers needs with a micro- and macro-economic outlook. The information provided by the system might include job families (current and emerging) with supplemental information on geographies, skill profiles, salaries, outlook, etc.

This information may be created in a scalable way by using, for example, machine learning and natural language processing, by applying them to various signals that contain this information (such as job descriptions 403 and other reports on macro-economic outlook from Bureau of Labor, etc.). The information may be enriched by applying human intelligence and provided via a service offering to parties of interest.

Solution Marketplace

As described earlier, competencies are imparted by solutions that include degree programs, training, certificates, apprenticeships, etc. In order to build effective guidance systems that enable an individual to select their optimal (personal) pathway, competency information is aligned against solutions that are available to achieve the competency.

A solution provider may align an existing solution (such as a program, course, and assessment) against a competency (or groups of competencies), and may understand the “gaps” as surfaced by the platform (via analytics dashboards, etc.) and create specific solutions to address the gaps

To create a marketplace of solutions, one or more of the following capabilities must be supported: (1) Ecommerce capabilities to support payments, (2) ratings, reviews, and reputation capabilities that enable the user of the solution to provide feedback on the efficacy of the solution, (3) in addition to ratings, etc., the system may mine the data already in the system to determine the efficacy of those solutions (for example, it might determine whether people that read/take a course/etc. do better on assessments, or better in the job, over time), and/or (4) analytics that provide insights such as what types of solutions are effective for what types of users; this information will be used by recommendation systems.

With above described capabilities (competency management, validation of competencies, labor market information system, and solution marketplace) available, multiple types of services may be provided. Service may include the ability to input an individual's (job seeker, student, people looking to skill up or change profession) basic profile (résumés, transcripts, etc.) into the system. Ability to use assessments 511, to create “validated skill profiles” 516 for the user. Ability to build profiles based on preexisting assessments 511 the user may have taken already. Enables access to the services offered via an application programming interface (API), on top of which a number of products, services, or systems are built 512 and provides the ability to import/export profiles 515 and access data via APIs in the system. Ability to determine “gaps” between a user's desired goal (as described by competencies) and where their current capabilities are. Ability to provide “badges” 516 as a way of persisting validity of an assessment output (including information about underlying competencies and levels validated on behalf of the user) so that the user may use the badges as a way of communicating validated skill profiles to the end users. Ability to propose various solutions for the individual so they may close these gaps. Ability to input various solutions (e.g., training/education content, information about apprenticeships, etc.) into the platform, as part of a market place (where external providers may view). Ability to rate the efficacy of the solutions offered to the employer 510a-c.

Further services may include tools for employers to use the competency methodology for “skill-based” hiring, enabling them to hire or consider hiring the right individual based on actual competencies and not necessarily proxies of competencies (such as degrees). Tools may include (a) ability to build job descriptions that include competencies required for the jobs and the “levels” associated with the competencies, (b) ability to look at validated skill profiles of job seekers, and (c) query-and-browse tools that may inspect and select users with the desired skill profiles (matching the job requirements) from a database that stores validated skill profiles of users.

In alternative example embodiments, services may include the ability to prevent “résuméspamming” or the practice of stuffing keywords into résumé so that the filters created by employers applicant tracking systems may be defeated while at the same time ensuring that people with right credentials (and not right keywords) are not overlooked, the ability for a user to understand the needs of the labor market, with respect to competencies required for job families, the ability to transmit the changing labor market needs (new skills required by employers, new job families emerging, existing skills beginning to trend down, signaling potential loss of jobs in the future, etc.). Example embodiments further provide the ability to extract competency information (including supplemental information such as levels, location, and/or other related requirements) from individual job descriptions, the ability to understand occupations in different industries that are similar to each other with regard to competencies. This information may be used to recommend jobs and up-skilling opportunities to candidates.

Further services include providing the ability to correlate validated skill profiles of candidates either who has been hired or who is being considered for hire to jobs and job competencies. The correlation data may be used to build predictive models and recommend jobs to candidates, the ability to understand common-gaps identified by the system and design training content to address these gaps, the ability to determine the quality of the content by the likelihood of a user taking the content getting hired, the ability for system to make it easy for candidates to apply to multiple jobs using their validated skill profile in the system and for the system to perform the application on the candidate's behalf, automatically, and the ability for employers/recruiters to search a database of candidates that match requirements and take actions such as perform lead generation, solicit to apply, etc. In addition, services may include creating custom hiring profiles for employers based on techniques such as criterion validation, content-based modeling, performing dynamic matching for employment opportunities as users add more signals, validations, etc. as well as using insights derived from longitudinal data measurements, and using longitudinal data and insights to predict what is important and predictive of job performance

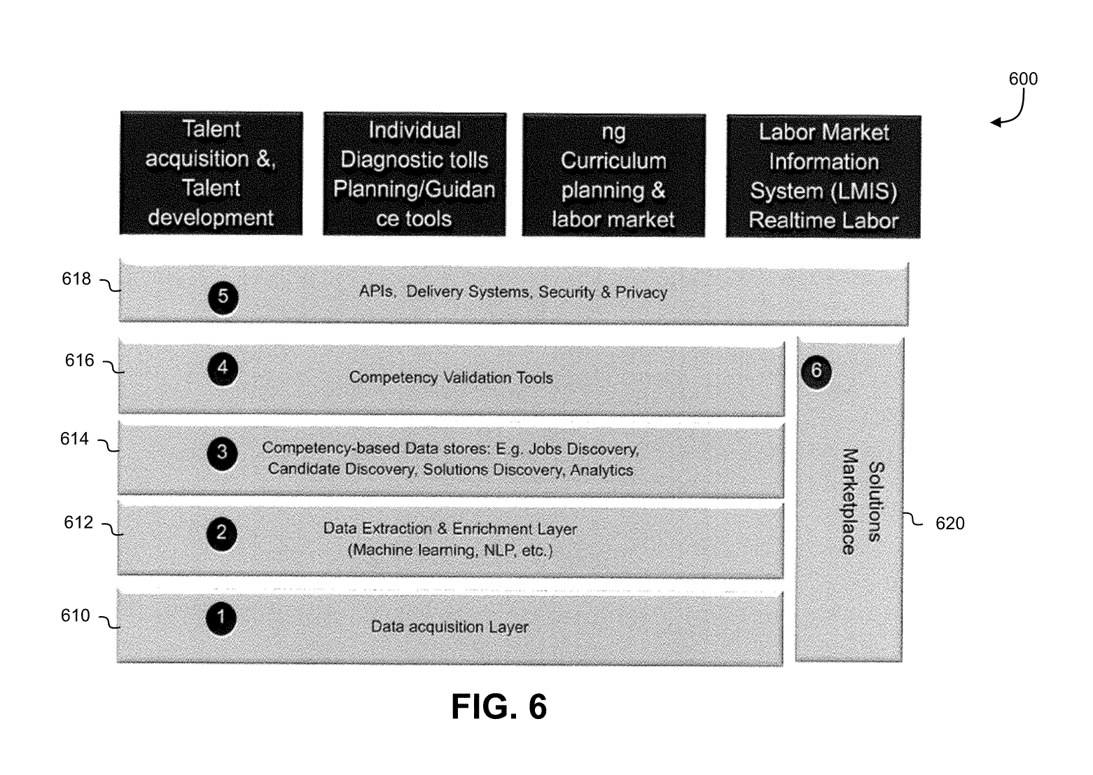

FIG. 6 is a block diagram of the layers of a determined Competency Management framework as might be implemented using networking and computing hardware and software. Some of the layers are described in more detail below, by way of example.

A data acquisition layer (610) includes acquiring documents containing some type of competency information from a variety of sources (e.g., web pages containing job descriptions, course description containing outcome statements, databases containing résumés, etc.). Documents may be structured (e.g., database input), semi-structured (e.g., a web page form with some free-flow information) or unstructured (form cannot be determined a priori). The output of this system is a storage system that contains the documents to be processed.

A data extraction layer 612 is illustrated, one example embodiment of the data extraction layer is to use a variety of techniques—some machine automated and some driven by human beings, to take the documents to be processed and output competency statements, with as much auxiliary information (such as “level” of skill) as is necessary and possible. The automated extraction is accomplished by a pipeline of one or more different machine learning algorithms, each with a specific purpose to continue enriching the data from the acquisition layer. In order to “train” the algorithms, human “data taggers” might be used, who have been trained to tag (or annotate) a subset of documents (training data sample) with the competency and other supplemental information that is extracted from the untrained data collection. The annotated data samples are fed to the “machine” (algorithms that have been built to create internal state (“objective functions”) that will enable them to output information in the form used to build the next stage of the technology stack.

The machine learning process is often supplemented by human curation and quality control. In addition to the competency information, extracted, additional layers of information might be created, such as the level implied in a document; for example, rookie (fresh college graduate) vs. expert (senior talent with significant experience) 622.

While millions of job postings are available online, in comparison, only a small subset of them (in the mid-to-high thousands) need to be annotated in order to produce the training data required to train the entity extraction software. Once trained, the entity extractor may be used to extract requirements and competencies automatically from unseen job descriptions.

Job descriptions enumerate several types of requirements. For the purposes of annotation and extraction, in one example embodiment the following types of requirements have been identified: (1) Primary Requirements, (2) Subordinate Requirements, (3) Education Requirements, (4) Certification Requirements, and (5) License Requirements. Each type of requirement in turn comprises one or more fields such as Activity, Subject, Subject-Qualifier, Activity-Qualifier, Person, Name, Years, Level, Required, etc.

Primary requirements describe the knowledge and/or skill an employee may need to make use of in their job. Subordinate requirements on the other hand detail the knowledge and/or skills, which may be important to a job but for which an employee may not be directly responsible. Separating primary and subordinate requirements is important to identify the skills a candidate would truly need to possess. Education, certification, and licensing requirements enumerate educational qualifications, certifications, and licensing needs as required by the job.

The entity fields contain information about “the 5 W's” (i.e., What, Who, Why, Where and When) and the H (How). For example, the subject field describes the “what” of a requirement. This will typically be an area of knowledge or skill. The activity field describes the action being performed on the subject or using the subject. While most requirements contain an activity and a subject, it is possible to have requirements with just an activity or just a subject. The subject-qualifier field also answers the question “what,” but at the next level of detail. The subject-qualifier, for example, may enumerate specific examples of the subject. Similarly, the activity-qualifier provides details about the activity, but by answering the question of “how” the activity is being performed. The person field answers the question of “whom” the activity is being performed with/for/to, etc. The “years” field describes the years of experience (e.g., 3-5 years) required in a given knowledge or skill area. The level field describes the level of the knowledge or skill (e.g., proficiency, expertise, etc.), and the required field describes the optionality of a requirement (“Must have” vs. “Nice to have” requirements).

When annotating a job description, an annotator might consider each requirement in the job description and mark it up appropriately depending on the type of the requirement (e.g., primary, subordinate, education, etc.) and the type of the field. The markups are spans of text within the job description that belong to a requirement and correspond to one of the fields described above. The extraction algorithm is trained using these annotations and learns the patterns for extracting requirements from unseen job descriptions.

The requirements thus extracted, while much more structured than a text document, are still in a raw form and not easily amenable to building applications. The next stage in the pipeline is responsible for processing these requirements into a form more useful for building applications. Each combination of requirement-and-field undergoes a potentially different type of processing.

The subject field in primary requirements is the main source of information for competencies required by a job. However, the same topic area could be written in potentially different ways. For example, “Accounts Receivable Management” could be written as such, or it could be written as “A/R Management” or it could be written as “Management of Receivables.” The processing for subjects will detect variations of the same topic area and normalize them into a canonical form. This is achieved using a combination of text clustering algorithms (such as Latent Semantic Analysis (LSA) or Latent Dirichlet Allocation (LDA)) as well as by making use of taxonomy.

In a similar manner, the activities extracted from a requirement are processed to determine level of a requirement. For example, the requirements for a person performing the work of managing receivables is different from the requirements for a person evaluating the work of others doing receivable management even though both requirement are about the same competency, i.e., “Managing Receivables” using “verbs” (the reference to verbs here does not imply that only verbs are used to level activities. Any word appearing within an activity phrase may potentially be used to identify the level of a competency. While verbs and nominalized verbs provide the most indications, adjectives such as “Responsibility” also provide important information with regards to level) to indicate competency levels is widely used in education and referred to as “Bloom's Taxonomy of Educational Objectives.”

Bloom's taxonomy categorizes the knowledge acquisition process into six progressive stages or levels—Remembering, Understanding, Applying, Analyzing, Evaluating, and Creating. Bloom's taxonomy primarily deals with the knowledge acquisition process and is inadequate in capturing all of the levels in the context of jobs. The activity leveling process therefore extends Bloom's taxonomy to include levels such as Communication, Collaboration, Coordination, Lead, Manage, and Mentoring. The extensions to Bloom's taxonomy do not need to follow the same principles as the original Bloom's taxonomy. For example, while the extensions do have progressions, the progression is not as clear-cut as in the case of the core taxonomy. This is not surprising since the extended levels provide information on abilities and abilities are not always progressive. Nevertheless, the extended Bloom's Taxonomy provides a framework for leveling activities extracted from a requirement to level the competency identified in the requirement.

While not enumerated here, it will be obvious to those of ordinary skill in the art that other combinations of requirements and entities might go through similar processing stages to glean appropriate information and make it available in a manner suitable for reasoning about and building applications.

Each of the stages of the pipeline produces enriched data elements. Based on the type of the data processed (e.g., job descriptions), it further processes the data to create data structures that are suitable for building applications. For example, the job competency information are finally linked to create a hierarchical occupational category and skills information database that may provide information on what skills (competencies) are associated with a given job family. One use of this data is to provide information to a job seeker on what competencies are required to work in a profession. Another use is for an educational institution to examine if a given program prepares a student to acquire the right sets of competencies expected by employers.

Competency-based databases 614 include a construction of several organized representations of data. All of the main databases contain information primarily designed around competencies, for example, job descriptions are stored at a series of competency statements and associated information; individual profiles contain validated and non-validated competency statements, reference check information, background information, etc. The information is stored using different structural representations that enable layers above to easily access and provide services based on these underlying representations.

Extracting structured competency information for a job enables the system to organize the available jobs in a number of different ways. For example, each job could be classified to a standard O*Net occupation (using the methods described earlier) which in turn allows for prioritizing competencies (using statistical methods, e.g., more frequently required competencies would be weighted higher. The prioritization could also be based on other criteria such as geography) for each occupation.

Using competency information, one may determine the closeness between two occupations and therefore deduce the extent to which skills from one occupation are transferrable to other occupations. An alternative organization is one where the jobs are clustered purely based on their competencies using automatic clustering algorithms. The resulting “Job Clusters” may or may not align with the occupations defined by BLS and O*Net. Nevertheless, such an organization is still extremely useful since it is based purely on competencies. Using such an organization one may reason about occupations that are similar to each other as well as occupations that may serve as stepping-stones to other occupations, e.g., occupations where candidates could gain the skills required by other occupations enabling career progressions.

On the Solutions side 620, the education portion of the system specifies which competencies are associated with a specific solution (e.g., a degree program, a course, a massive open online course (MOOC), a certificate or badge, etc.). There are various ways to achieve this and a few are as follows: (1) Competency-based programs provide explicit competency statements that may be mapped to the taxonomy, (2) For non-competency-based programs and courses, a Degree Qualification Planning (DQP) might provide methodologies to map outcome descriptions from non-competency based courses into a form that clearly expresses the competencies inherent in the courses (and programs), and for other education/training content, the system allows for working with the providers of the content to obtain information about the specific competencies that are assessed via high-stakes exams after the completion of the program, as well as using machine-learning tools to extract outcome information and provide that as input for instructional designers to validate.

Below are examples of some competency statements from job descriptions, résumés and assessments.

### Example 1

### Develop, Manage and Implement a Testing Plan to Ensure the System Meets End User Requirements. Use QMetry/Jira to Capture Test Scripts and Test Results

Extracted Competency Statements (as Might be Stored in a Competency Table) from Example 1 Description:

| | |
|---|---|
| Competency | Level of Competency |

Primary Requirements

| | |
|---|---|
| Test Plans | Creation |
| Test Plans | Management |
| Test Plans | Application of Knowledge |
| QMetry | Application of Knowledge |
| Jira | Application of Knowledge |

Subordinate Requirements

| | |
|---|---|
| End User Requirements | Operational (Meet expectations) |
| Test Scripts | Operational (Meet expectations) |
| Test Results | Operational (Meet expectations) |

### Example 2

### Study and Make Recommendations Regarding Credit Risk Management, Customer Profitability, Resource Allocation and Optimization, Customer Segmentation

Extracted Competency Statements from Example 2 Description:

Primary Requirements

| Competency | Level of Competency |
|---|---|
| Credit Risk Management | Analyze |
| Credit Risk Management | Evaluate |
| Customer Profitability | Analyze |
| Customer Profitability | Evaluate |
| Resource Allocation and Optimization | Analyze |
| Resource Allocation and Optimization | Evaluate |
| Customer Segmentation | Analyze |
| Customer Segmentation | Evaluate |

### Example 3

### Bachelor's Degree with Emphasis in Finance, Accounting, or Other Business Related Field

Extracted Competency Statements (as Might be Stored in a Competency Table) from Example 3 Description: n/a. Extracted Requirement Statements (as Might be Stored in a Database Table) from Example 3 Description:

Education Requirements

| Subject | Level of Education |
|---|---|
| Finance | Bachelor's |
| Accounting | |
| Other Business Field | |

Competency Validation Tools 616

In the case of individuals reporting their competencies, often validation is required, especially in certain class of high-risk or high-compliance jobs. In these cases, employers require that job seekers take assessments that are constructed in a way that the results are psychometrically valid.

Because of the high-cost of the assessment instruments, employers often reserve assessing only a select number of finalist candidates. However, due to the issue of résumé spamming discussed earlier, this implies that a number of candidates who may not really have the skills required may end up as finalists, affecting the quality of the pool. An application programming interface (API) 618, on top of which a number of products, services, or systems are built and provides the ability to import/export profiles and access data via APIs in the system enables assessment instruments to be readily or more readily available for candidates and employers.

On the other side, due to the use of keywords used in applicant tracking systems, qualified candidates who are not using the “correct” keywords are left out of the process. Assessments are typically delivered via proctored physical locations, severely limiting access to the process. Assessments are often very long inconveniencing test takers, especially since they may have to take similar tests at multiple employers during their job search process.

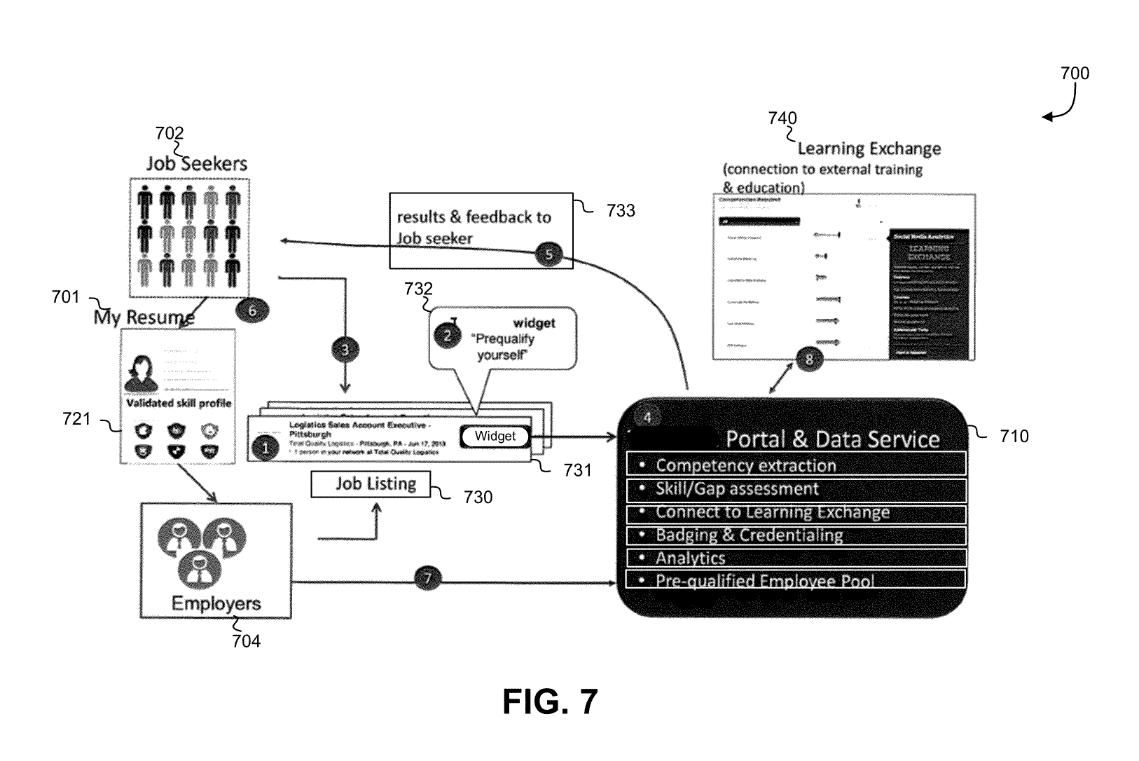

FIG. 7 illustrates a data mining assessment system 700 according to example embodiments of the present invention. Instead of a traditional assessment strategy, the data mining system delivers assessments and provides a validated skill profile to the employer 704 from its own platform (as shown in FIG. 7). This enables multiple benefits, for example, once the job seeker 702 takes assessments for competencies for a job that requires it at an employer, they are able to reuse the assessments for jobs at other employers that require similar competencies; the system enables the job seekers to take assessments online.

In order to enable this, the system may be configured to work with assessments partners to assist them in the following: enabling test security (e.g., authentication of user, ensuring that users are not cheating, etc.) and assisting in developing large item banks that makes it difficult for test takers to reuse past tests easily. This includes technologies such as cloning items while maintaining test validity, reducing the time to test an item (“paired testing”) using Internet practices such as crowd sourcing, creating new items, such as reading passages with similar degree of preference, using machine learning techniques; and assisting them in delivering tests via adaptive testing frameworks, using methodologies such as Item Response Theory (“IRT”).

In some example embodiments, the data mining operation may “consumerize” assessments (i.e., make it accessible and easy for a consumer to take assessments) by reducing the time required to take an assessment significantly. To accomplish this, one or more of the following may be used:

Example embodiments enable the use of competency extraction processing 711 on job description to ensure that assessments for the job only test for the competencies required for the job, rather than a plethora of competencies in a long test form. To achieve this, for example, embodiments presented herein include measuring the competency level expected in the job (or use other strategies such as asking the test taker for additional input) and, in some instances, only use test items required to validate the level and/or relaxing the requirements to precisely measure the absolute results of a test, instead, verify whether the test taker is in range for the level of skills required, etc.

The data mining system may be configured to detract from résuméspamming, losing good candidates to keyword filters, and the like, by operating as an employment data service 710, wherein rather than large post-filter costs paid by employers and repeated testing of job seekers, the data mining system operator might pay testing fees to allow a job seeker to be assessed, but needing to only do this once. Then the data mining system operator may charge individual employers to provide data and/or assessment results. Assessment results might be indicated by a logo or other indicia (e.g., a cryptographically secure “badge” 714) that indicates a competency or other assessment. The job seeker may then use the badge in their validated skill profile 721 for all other similar jobs for which he/she applies.

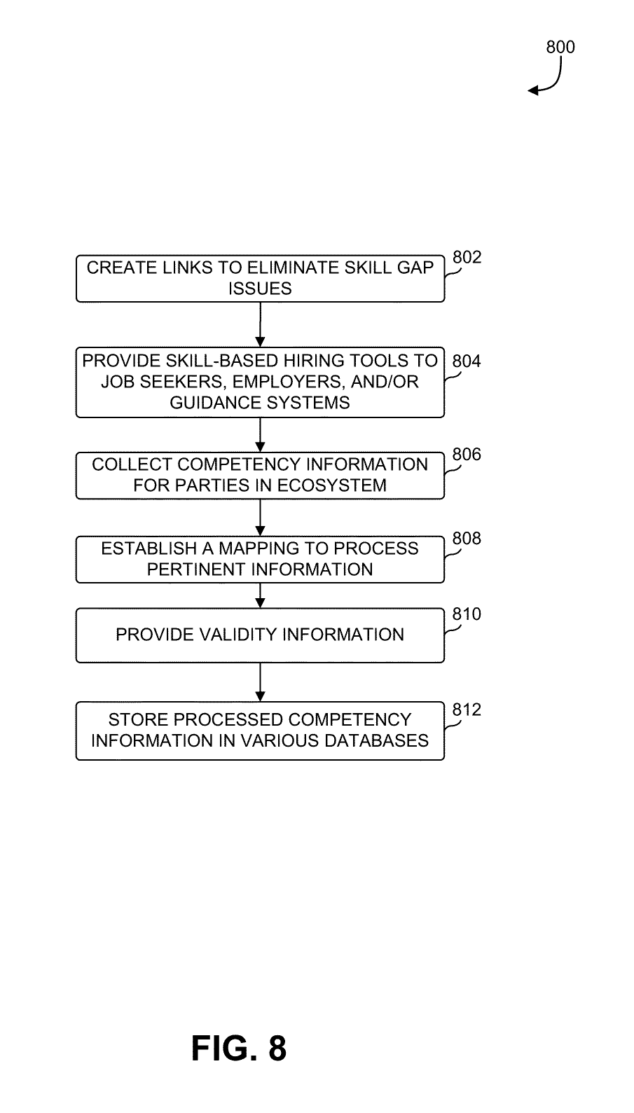

FIG. 8 is an example embodiment of a process for providing validity information for employers, job seekers, and/or educational provider systems.

“Competencies” are collections of job skills, cognitive abilities, behavioral traits, etc. necessary to perform work roles or occupational functions successfully.

Competencies may be the unit of granularity used herein for the candidate systems, the employer systems, and the educational provider systems. Employers require employees with competencies to perform the job functions, individuals have competencies and may need to gain additional competencies to become employable (or skill up) and education/training and other solutions (such as internships, intermediate jobs) impart competencies.

Assessments provide ability to measure competencies in individuals so that employers may hire them (even if they lack degrees or credentials) and individuals may use them to select the right solutions so that they may become more employable.

Creating linkage eliminates skill gap issues 802 by providing skill-based hiring tools for employers and guidance systems for job seekers 804 to understand their current competencies and skill-up by using appropriate solutions. By providing a view of the labor market needs and tools for aligning curriculum to the market needs, degree gap may be addressed. Using a guidance system that shows what the labor market opportunities are and competencies required by employers as well as by showing the competencies gained by education or training, planning gaps may be reduced.

To use competencies as linkage, competency information from all three players in the ecosystem is collected 806, processed (in a computational sense, using machine learning and natural language processing, for example) and normalized (using techniques such as taxonomies and semantic webs). The normalized competencies data serves as the linkage between the three systems.

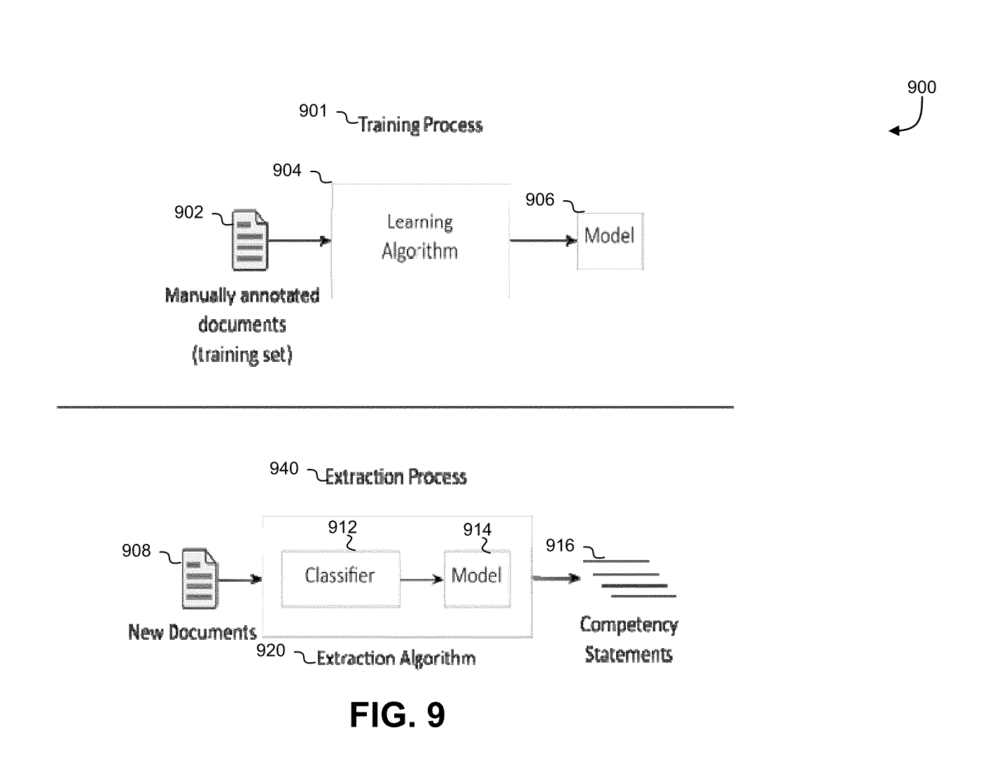

FIG. 9 is an illustrative example of a block diagram in accordance with at least one embodiment for training processes 901 and extraction process 940 using an extraction algorithm 920 to receive manually annotated documents 902, such as training sets, provide them to a learning algorithm 904, and produce a model 906. Whereas the extraction process provides new documents 908 to the extraction algorithm 920 using a classifier 912 and a model 914 to create the competency statements 916.

Once the mapping is established, using technologies to process pertinent information from each parts of the ecosystem 808. For representing labor market needs, the instruments may be job descriptions as well as other auxiliary information (such as the plans to create a new manufacturing plant in a state in the future) or macro conditions such as the discovery of oil under shale or treaties such as the North American Free Trade Agreement (NAFTA), from which future needs, may be projected. For representing competencies of individuals, résumés, transcripts, certificates and badges may be used. However, instruments such as résumés are un-validated instruments. In order to provide the validity those employers need (and defeats résuméspamming—the practice of adding extensive keywords into a résumé so the filters set up by in-house), assessments may be used 810. “Badges” refer to system-generated indicia of authentication of particular competencies. For representing competencies imparted by education and training, metadata from curriculum construction that describes outcomes measured by the programs may be used.

The processed competencies are stored in various databases 812 (described in more detail below) and turned into a dynamic data service that provides various types of data services including what competencies required to work in a given occupation, which competencies are rising in demand, which ones are becoming obsolete, what is the future outlook for an occupational category, what competencies are provided by an educational program or training and what competencies are implied in a résumé. The data services of the data mining system could provide a platform on which to build applications such as skill-based hiring tools, guidance systems, etc. In addition, the data service allows for dynamic pricing for profile data based on market demand.

Assessments of competencies, modified so that the assessments have the option of measuring only the specific competencies that a job requires (as opposed to a generic assessment are part of the solution. Assessments have the type of “validity” required by the employers for jobs that may be critical (such as most health care jobs or jobs in a nuclear plant). Assessments also need to be available online so that individuals may take them any time (even when they are not looking for a job). Online assessments are secured to ensure authenticity of the test taker as well as detracting cheating.

As for the degree gap, with access to an accurate picture of what the labor market values today and the future (through predictive analytics and/or the like), institutions (or providers in general, including employers) are able to create solutions (degrees, courses, certificates, etc.), to address those needs. Outside of the institutions, using the analytics provided by the system that quantify gaps seen in skill-profiles, experts may create content and assessments to impart and validate competencies.

As for the planning gap, by providing information about what the labor market values today (and in the future), and with access to information about solutions and their alignment to the labor market needs, individuals (e.g., students, workers looking to skill up, etc.) are better able to plan their specific pathway to their goals.

As for the skill gap, by focusing on “competencies” when communicating skill profiles to an employer, the candidate selection criteria becomes more normalized and quantifiable. By providing feedback to job seekers 733 on gaps in competencies, the job seekers are able to take action to enhance their employment potential by acquiring and validating the necessary competencies.

Solution Strategy

The data stored by the data mining system may feed into one or more processing subsystems or platforms, such as a competency management subsystem, a competency validation and testing subsystem, a labor market information system, and a solution marketplace.

Competency Management Subsystem (“CMS”) 916

One taxonomy parses a competency to a node associated with one of three aspects of competencies: (1) job skills, (2) cognitive ability and (3) behavioral traits. Other variations are possible. The CMS may “extract” competency information from structured or semi-structured documents that contain them, for example, job descriptions, résumés, and assessment outcome descriptions.

Using competencies latent in job descriptions, résumés and assessments, continual creating/updating of a number of different data bases (including traditional relational databases, hierarchical databases and new key-value based databases).

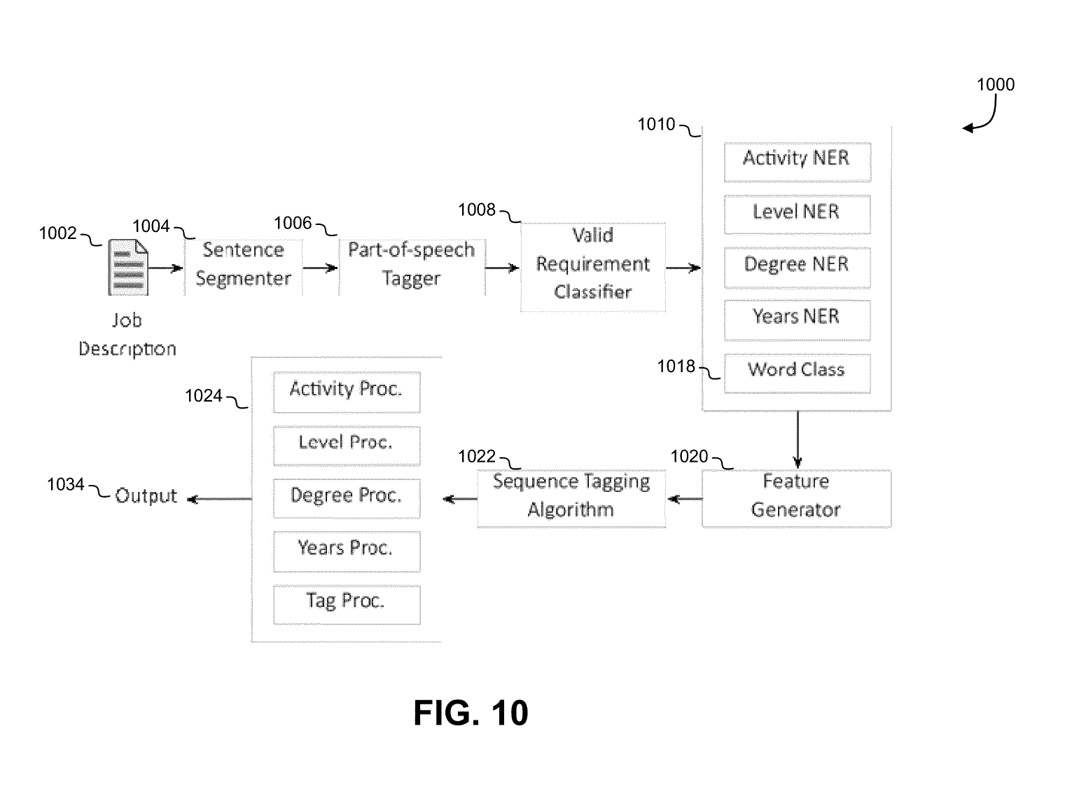

FIG. 10 shows an example embodiment of the detailed architecture of the extraction system.

The training and extraction pipeline are quite similar. The given job description 1002 is first passed through a “sentence segmentation stage” of a sentence segmentor 1004 to extract sentences from a job description. The extracted sentences are then passed through a Part-of-Speech tagger to tag the tokens with their equivalent part-of-speech tags. This part of the pipeline is common for most natural language processing (NLP) tasks. The next stage in the pipeline (i.e., valid requirement classifier 1008) determines the probability that a given sentence could be a job requirement. This stage helps distinguish generic sentences in a job description from sentences that may indicate a requirement. Sentences that are potentially valid job requirements are then passed through a number of named entity recognizers (NER) 1010 and a word class annotator 1018 to understand the structure of the sentence. The output from this stage is then sent to a feature generator 1020, which massages the output from the NERs and the word class annotator into a format understood by the Sequence Tagging algorithm 1022. The Sequence Tagging algorithm 1022 uses the sentence structure as described by the feature generator to extract structured information from requirements. The extracted output 1034 is post-processed through the same NER processes 1024 to extract the relevant information from the extracted output.

The Annotation Specification

For a practical system, it is important to use as many annotators to annotate job descriptions as possible. However, each annotator may perceive the requirements in a job description differently. Variations in the annotation can easily confuse the algorithm and cause it to learn the wrong patterns. It is important to ensure that the annotation output from the different annotators is consistent so that the algorithm can learn the correct patterns. However, job requirements can be written in so many different ways that specifying the correct annotation for every possible case is humanly impossible. Therefore, the specifications are defined at a conceptual level emphasizing “the 5 W's and the H” of a requirement. The numbers of ways in which these 6 concepts can be linked to form a requirement are much fewer and it would be an easier task for an algorithm to recognize these similarities and learn the structure. A detailed annotation guidelines document is provided in the Appendices. This section serves to highlight some aspects of the guidelines.

Identifying Activities and Activity-Qualifiers

Activities define the “doing” part of a job requirement. This is usually the verb or verb phrase in a requirement. However, this may not always be true. Job requirements often make use of nominalized verbs, and it is possible to write requirements with no verbs or verb phrases. However, such requirements could still have an activity.

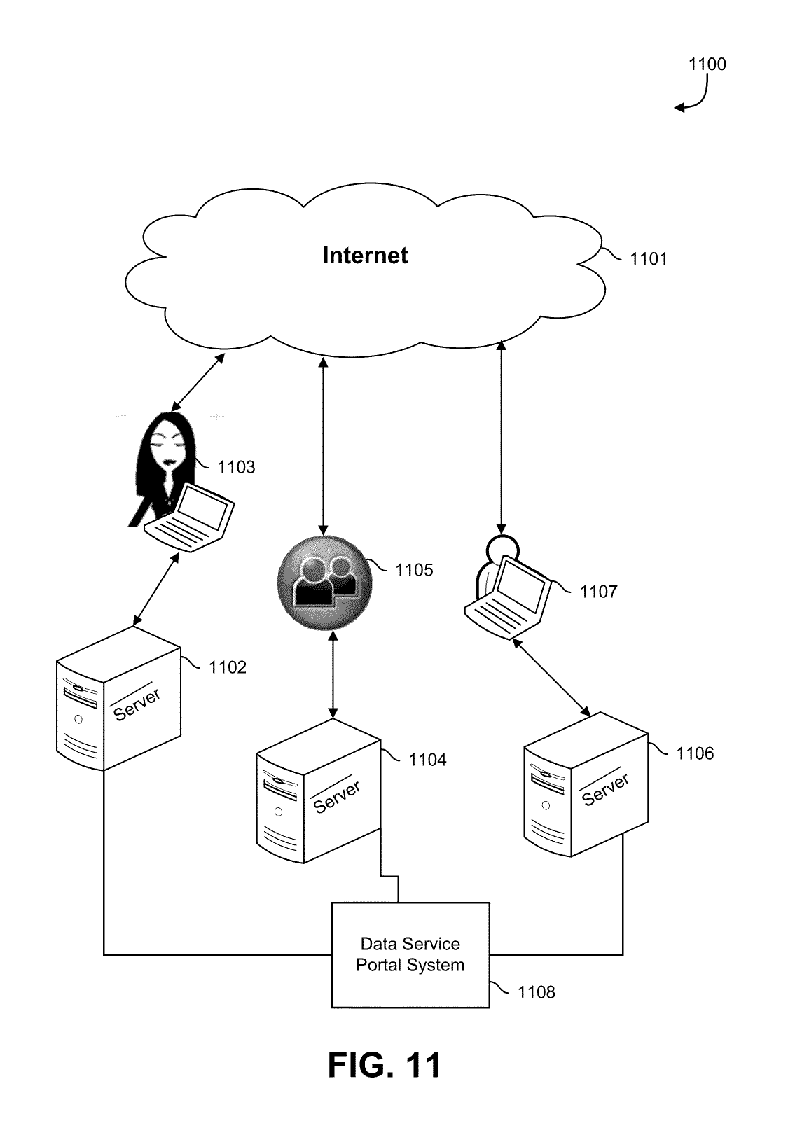

FIG. 11 is an example embodiment of interconnected computer systems 1100 that might be used to connect candidate systems 1102 for job seekers 1103, employer systems 1104 for employers 1105, and educational provider systems 1106 for providers 1107.

The following examples illustrate activities in job requirements:

### Example 1.1

Execute all off-boarding related activities

| Type | Subject | Activity |
|---|---|---|
| Primary | all off-boarding related | Execute |
| | activities | |

The “doing” in this requirement is the verb “Execute.” Execute therefore defines the activity in this requirement.

### Example 1.2

Timely response to both internal and external customer requests

| | | | |
|---|---|---|---|
| Type | Subject | Activity | Qualifiers |

| | | |
|---|---|---|
| Primary | both internal and | Timely response to |
| | external customer | |
| | requests | |

This requirement has no verbs. However, it does have an activity (e.g., “timely response to”). The requirement here is for the employee to respond in a timely manner. The appendix has many more examples for activities as well as the different nuances in which activities can be described.

### Example 1.3

Respond in a timely manner to both internal
and external customer requests

| Type | Subject | Activity | Qualifiers |
|---|---|---|---|
| Primary | both internal and | Respond | Activity-Qualifier: in a |
| | external customer | | timely manner to |
| | requests | | |

The verb in this case is “Respond,” which is also the activity. The prepositional phrase “in a timely manner to” describes how the employee should respond, and functions as an activity-qualifier. Activity-qualifiers will be discussed later in the section.

### Example 1.4

Establishes and maintains standards

| | | | |
|---|---|---|---|
| Type | Subject | Activity | Qualifiers |

| | | |
|---|---|---|
| Primary | standards | Establishes and |
| | | maintains |

In Example 1.4, there are two activities acting upon the subject, “standards.” This is considered a compound activity. Occasionally, an activity-phrase may be annotated. Consider the following example:

### Example 1.5

Provides oversight for enrollment and
insurance eligibility activities

| | | | |
|---|---|---|---|
| Type | Subject | Activity | Qualifiers |

| | | |
|---|---|---|
| Primary | enrollment and | Provides oversight |
| | insurance eligibility | for |
| | activities | |

The verb in this requirement is “provides.” However, as an activity “provides” is not very meaningful. Analyzing the requirement, one can see that the activity that is really called for is “providing oversight” (“oversight” is a nominalized form of the verb “oversee”). Thus, the activity in this case is “Provides oversight” and the subject (e.g., ask the question: “Oversee what?” and the answer becomes clear) is “enrollment and insurance eligibility activities.”

It can be difficult to know when it is appropriate to add a nominalized verb to a verb to create an activity-phrase: the rule-of-thumb is to determine if adding the verb and the nominalized verb together creates an activity-phrase that is consistent with the meaning of the nominalized verb on its own (e.g., “make recommendations” has a meaning consistent with “recommend”). Examples of when to do this include “make decisions” (decide), and “provides guidance” (guide). However, consider a requirement such as “seeks guidance.” In this instance, “seeks” would be the activity on its own. Though “guidance” is a nominalized form of “guide,” “seeks guidance” does not provide the same meaning as “guide,” and therefore, the two should not be annotated together as the activity-phrase.

The other criterion for annotating an activity-phrase is that there also is a separate subject, on which the activity-phrase acts. It is sometimes difficult to ascertain whether a nominalized verb is intended to be considered as an activity, or as a subject. The existence of qualifiers preceding the nominalized verb can cloud the issue and introduce uncertainty to annotations. The only absolute indicator that an activity-phrase has been intended is the existence of a second subject within the requirement, which is being acted upon by the activity-phrase. Consider the following set of examples:

### Example 1.6

Provide financial guidance to clients

| Type | Subject | Activity | Qualifiers |
|---|---|---|---|
| Primary | financial guidance | Provide | Subject-Qualifier: to clients |

### Example 1.7

Provide financial guidance to clients on budgetary management

| Type | Subject | Activity | Qualifiers |
|---|---|---|---|
| Primary | budgetary | Provide financial | Person: clients |
| | management | guidance | |

In Example 1.7, it is evident that “financial guidance” is meant to part of the activity, as it is followed by a trailing preposition that leads to a separate subject the individual is meant to provide guidance on: “budgetary management.” It is clear, therefore, that “Provide financial guidance” is meant to be taken as an action. In Example 1.6, an activity-phrase would not be annotated, as there is no second subject—“clients” is who the guidance is being provided to, not what the financial guidance regards. Note that the location of “to clients” in the requirement determines its annotation—this will be discussed further in the Person section. Consider another set of examples:

### Example 1.8

Make staffing recommendations to HR

| Type | Subject | Activity | Qualifiers |
|---|---|---|---|
| Primary | staffing | Make | Subject-Qualifier: to HR |
| | recommendations | | |

For Example 1.8, “Make” is annotated alone as the activity.

### Example 1.9

Make recommendations regarding staffing decisions to HR

| Type | Subject | Activity | Qualifiers |
|---|---|---|---|
| Primary | staffing decisions | Make | Subject-Qualifier: to HR |
| | | recommendations | |

For Example 1.9, there is a clear subject the individual is making recommendations on (“staffing decisions”). Therefore, the system annotates “make recommendations to” as the activity-phrase, and “staffing decisions” as the subject. Note that “regarding” has not been annotated: it is preferable not to annotate prepositions as the start of a subject.

Occasionally, nontraditional activity-phrase annotations are allowable, as long as they satisfy the two criteria of activity-phrases: 1) a meaning consistent with nominalized verb, and 2) acting on a second subject. Consider the following requirement:

### Example 1.10

Acts as liaison between the sales and delivery teams to ensure adequate
scope definition, ongoing scope management, and recommendation of
delivery resource skill set into an overall project plan

| Type | Subject | Activity | Qualifiers |
|---|---|---|---|
| Primary | ensure adequate scope | Acts as liaison | Person: sales and |
| | definition, ongoing | between | delivery teams |
| | scope management, | | |
| | and recommendation | | |
| | of delivery resource | | |
| | skill set into an | | |
| | overall project plan | | |

Here, “Acts as liaison between” has a meaning that is consistent with “liaise between,” and is acting on a secondary subject. This would be considered an atypical activity-phrase due to the existence of “as” between the verb and nominalized verb; however, it functions as an adverb and as such does not disallow an activity-phrase annotation. Conversely, consider the following requirement:

### Example 1.11

Act as liaison between managers and staff

| | | | |
|---|---|---|---|
| Type | Subject | Activity | Qualifiers |

| | | |
|---|---|---|
| Primary | liaison between | Act as |
| | managers and staff | |

For Example 1.11, the system would not annotate an activity-phrase, as it does not satisfy the second criteria. If the system were to annotate “Act as liaison between,” this only leaves the person entity of “managers and staff,” which is not in the context of direct subject. As such, the second criterion is not satisfied, and the system must instead annotate only “Act as” as the activity. The system annotates “liaison between managers and staff” in entirety as the subject, in order for it to be meaningful.

It is important when annotating the activity to consider the true intent of a requirement. Occasionally there may be a requirement with multiple verbs (not a compound activity or multiple requirements), and the more meaningful verb that truly conveys the intent of the requirement may not be the first verb. Consider the following examples:

### Example 1.12

Be responsible for eliciting requirements

| | | | |
|---|---|---|---|
| Type | Subject | Activity | Qualifiers |

| | | |
|---|---|---|
| Primary | requirements | Eliciting |

It might initially appear that “responsible for” is the activity of this requirement; however, the true intent of this requirement is expressed by the verb “eliciting.” In the context of this requirement, “responsible” is not meaningful—though this is determined on a case-by-case basis. Capturing the true intent of each requirement can mean not annotating verbs that do not reveal the intent of the requirement. That may suggest that “be responsible for” should no longer be included with the text, however, that is incorrect. When there are requirements that begin with less meaningful activities (e.g., “responsible for”), or end with phrases that do not add meaning to the requirement itself (e.g., “where necessary”), the system does not annotate this language, but include it in text, as it adds meaning to the algorithm. Without its inclusion, the algorithm will not learn to ignore it (for what constitutes a meaningless phrase, see the final section of this document, “Unnecessary Annotations”). This logic does not extend to entire sentences that are meaningless—the algorithm learns to ignore such sentences in an indirect way.

On that note, when “be” precedes “responsible for” (or similar language such as “accountable for”), even when it is the meaningful activity of the requirement, the system does not annotate it, but simply include it in text. The algorithm recognizes “be” as a verb, and as such, will extract it as the activity, unless it learns to ignore it. To this end, “be” should be included in text in whatever context it occurs, but never annotated.

When a sentence has multiple requirements, the system annotates these as separate entities, regardless of any loss of context (and therefore, meaning) that may occur with the second or third entity. Consider the following example: “Understand OLCC/WSLCB liquor regulations and required compliance (e.g., NSF check collections, unpaid balances following communication with customer and sales department contacts, etc.) and be able to apply as required.”

### Example 1.13

Understand OLCC/WSLCB liquor regulations and required compliance
(e.g. NSF check collections, unpaid balances following communication
with customer and sales department contacts, etc.)

| Type | Subject | Activity | Qualifiers |
|---|---|---|---|
| Primary | OLCC/WSLCB | | Level: |
| | liquor regulations | | Understand |
| | and required | | Subject-Qualifier: |
| | compliance | | e.g. NSF check |
| | | | collections, unpaid |
| | | | balances following |
| | | | communication with |
| | | | customer and sales |
| | | | department contacts, |
| | | | etc. |

### Example 1.14

and be able to apply as required

| Type | Subject | Activity | Qualifiers |
|---|---|---|---|
| | | Apply | Level: |
| | | | able to |

This is a complex set of requirements for several reasons, but the most important takeaway is that the second entity (“be able to apply as required”) should be annotated separately, regardless of its loss of context and meaning when separated from the subject in the first entity. Notice as well that “as required” (and “be”) is not annotated with the second entity, but included with the text: this is another example of text that should not be annotated, but provides meaning to the algorithm. With the first entity, notice that there is no activity listed: this is because here the system considers “understand” to be a level, not an activity. However, the same guideline does not apply to verbs such as “learn,” “master,” or “demonstrate,” which should generally be treated as activities. In some example embodiments, regarding “demonstrates” as an activity, occasionally there are instances in which it precedes a level field, second activity and subject, in which it is clearly not the meaningful activity (Similar to certain instances of “responsible”). When “responsible” is not the meaningful verb, it is included in text, but not annotated. However, the system cannot treat “demonstrates” similarly, in which the system determines whether it is the activity of intent and annotate it (or include it in text) accordingly. “Demonstrates” does not occur with the same frequency as “responsible,” and as such, the algorithm does not have sufficient opportunity to learn two separate approaches. As such, the uniform approach to “demonstrates” is to annotate it as the activity whenever it occurs, regardless of whether it is followed by a more meaningful activity.

In alternative example embodiments, if a requirement read, “A demonstrated ability to . . . ,” “demonstrated” would then be annotated as part of the level. And similarly, there are requirements where the system would annotate “understand” as an activity. Consider the requirement:

### Example 1.15

Quickly understands business problems and opportunities in the context
of the requirements, systems capabilities

| Type | Subject | Activity | Qualifiers |
|---|---|---|---|
| Primary | business problems | Quickly understands | Activity-Qualifier: |
| | and opportunities | | in the context of |
| | | | requirements, |
| | | | systems capabilities |

In the context of Example 1.15, “quickly understands” is clearly an activity, not a level. This is evident by the preceding adverb of “Quickly.” There are many requirements for which it is debatable whether “understands” is meant as a level, or an activity. The only instances where it is unmistakable that “understands” be construed as an activity are when it is accompanied by some form of signifier (e.g., an adverb, or as part of a compound activity). As it would be impossible for the algorithm to discern on its own whether “understands” is meant as an activity or level in each context (as that relies on real-world knowledge), the system should therefore only annotate “understands” as an activity when 1) it is accompanied by an adverb that removes any doubt that it is meant as an activity, 2) is part of a compound activity, 3) is preceded by an entirely separate level qualifier, or 4) is in the context of a subordinate requirement.

Unlike subject-qualifiers that answer the question “what,” activity-qualifiers qualify the activity by answering the question “how?” Consider the example:

### Example 1.16

Experience writing queries and reports using reporting software

| Type | Subject | Activity | Qualifiers |
|---|---|---|---|
| Primary | queries and reports | Writing | Level: |
| | | | Experience |
| | | | Activity-Qualifier: |
| | | | using reporting |
| | | | software |

The activity in this case is “writing.” “Using reporting software,” describes how the employee should write, and functions as an activity-qualifier. The qualifier in this example follows the activity, and is therefore annotated as an activity-qualifier. Qualifiers can also precede the activity, but they are then annotated with the activity. Consider the following example:

### Example 1.17

Effectively communicate sales targets to managers and sales professionals

| Type | Subject | Activity | Qualifiers |
|---|---|---|---|
| Primary | sales targets | Effectively | Subject-Qualifier: |
| | | communicate | managers and sales |
| | | | professionals |

The qualifier “effectively” also answers the question “how.” However, here the qualifier would be annotated as part of the activity, as it precedes it.

It can occasionally be difficult to know when to annotate certain phrases as a subject-qualifier vs. an activity-qualifier. For instance, consider the following requirement:

### Example 1.18

Develops supplier evaluation and selection criteria for each spend
category as part of overall procurement and vendor management strategy

| Type | Subject | Activity | Qualifiers |
|---|---|---|---|
| Primary | supplier evaluation | Develops | Subject-Qualifier: |
| | and selection | | for each spend |
| | criteria | | category |
| | | | Activity-Qualifier: |
| | | | as part of overall |
| | | | procurement and |
| | | | vendor management |
| | | | strategy |

One could conceivably view “as part of . . . ” as a subject-qualifier or activity-qualifier, depending on how the question is framed. However, with the correct lens it is evident that “as part of . . . ” does not qualify the subject, but the activity: it tells the system how the individual should develop supplier evaluation and selection criteria—as a part of the overall strategy. Consider the following example:

### Example 1.19

Works independently with minimal supervision

| Type | Subject | Activity | Qualifiers |
|---|---|---|---|
| Primary | | Works | Activity-Qualifier: |
| | | | independently with |
| | | | minimal supervision |

It is allowable to have multiple activity-qualifiers or subject-qualifiers. This would occur if, say, the above requirement were rephrased so that the two activity-qualifiers were separated within the requirement. They would then be annotated as two separate activity-qualifiers. However, when the system identifies connected activity-qualifiers such as “independently with limited supervision,” the system would annotate it as one unbroken activity-qualifier, not two (e.g., “independently,” and “with limited supervision”).

Very occasionally, one might discover two standalone activities without subjects. These should be treated identically to standalone subjects without activities (see below section). If they share any connective word between them, they should be annotated together as a compound activity. Consider the following example:

### Example 1.20

Ability to self-start and work independently in a dynamic environment

| Type | Subject | Activity | Qualifiers |
|---|---|---|---|
| Primary | | self-start and work | Activity-Qualifier: |
| | | | independently |

In this example, the standalone activities of “self-start” and “work” actually share two connective words/phrases: “ability to” and “independently.” As such, they should be annotated together as a compound activity. Notice that “in a dynamic environment” is not annotated. This is an example of a meaningless phrase that need not be annotated (see “Unnecessary Annotations” section). As such, the system includes it in text, but do not annotate it. If this requirement read as “Self-start and work in a dynamic environment,” the system would annotate the two activities separately. As “in a dynamic environment” is not meaningful enough to annotate, it does not serve as a connective word. Only language that is annotated can serve as a connector between standalone subjects or activities. Phrases that are only included in text do not serve to connect standalones.

Identifying Subjects and Subject-Qualifiers

The subject identifies the “what” of a requirement, which is usually defined by nouns or noun-phrases. Identifying the subject in simple job requirements is more or less straightforward. However, identifying the subject in longer requirements demands thought. The goal is for subjects to be meaningful and short, but not over-specific or generic. For many requirements, the annotator must weigh a choice between annotating a short subject or a meaningful subject. When confronted with this choice, one should always err with annotating a meaningful subject.

The noun-phrase that constitutes the “what” may be qualified using adjectives and/or prepositional phrases. When subjects are preceded by adjectival qualifiers, they should always be included with the subject. Consider the following example:

### Example 2.1

Develop successful integrated marketing programs

| Type | Subject | Activity |
|---|---|---|
| Primary | successful integrated | Develop |
| | marketing programs | |

The “what” in the requirement (i.e., “programs”) is too generic. But as it is preceded by the adjectival phrase “successful integrated marketing,” it is included as part of the subject, making it specific and meaningful.

Though all preceding qualifiers are annotated with the subject, the system cannot maintain such a uniform approach to prepositional phrases following the subject, which is not as straightforward. The following list of guidelines is an attempt to draw a clear line between what should be annotated as a subject vs. subject-qualifier. These guidelines should be looked at as formalized reinforcements of the intuitive logic instinctively used to determine subjects from subject-qualifiers. It is important to adhere to guidelines, but they must always be considered (and occasionally broken) in the context of each individual requirement. Examples for each guideline will follow later in the section.

Subjects should generally not include specific examples, sub-sets, components, or criteria of the subject: these generally belong in subject-qualifiers. Examples are often preceded by connectors such as “including,” “such as,” “e.g.,” “i.e.,” “to include,” “preferably,” etc. These connectors should also be included in the subject-qualifier.

Prepositional or adjectival phrase containing person entities, which describe who the task/subject is for/from/to, etc., should generally be annotated as a subject-qualifier (though if the subject is very generic, they can be included with the subject to make it meaningful).

Requirements often consist of multiple prepositional phrases following the direct subject. Multiple prepositional phrases should not all be annotated with the subject: only those necessary for the subject to be meaningful. Often, the first prepositional phrase may be necessary to annotate with the subject, for it to be meaningful. Very rarely, two prepositional phrases are necessary to create a meaningful subject. Usually, the second prepositional phrase describes only a secondary or indirect subject, and should be annotated as the subject-qualifier.

Any content in parentheses following the subject noun-phrase should be annotated as a subject-qualifier. Exception to this guideline occurs when parenthetical phrases are embedded within the subject, or, when the parentheses merely contains the acronym for the subject).

Any prepositional phrase following a subject that consists of skills/abilities/experience (e.g., “communication skills”) should generally be annotated as a subject-qualifier. Any phrase following the subject that answers the “why” question, but does not qualify as a subordinate requirement should generally be annotated as a subject-qualifier (this guideline will be discussed in the Subordinate section). Consider this Guideline 1 example:

### Example 2.2

Experience working with data extraction tools, such as Business
Objects, SQL

| Type | Subject | Activity | Qualifiers |
|---|---|---|---|
| Primary | data extraction tools | working with | Level: |
| | | | Experience |
| | | | Subject-Qualifier: |
| | | | such as Business |
| | | | Objects, SQL |

Here, “Business Objects” and “SQL” are types of data extraction tools used, and as such are appropriate subject-qualifiers. Consider another Guideline 1 example:

### Example 2.3

Oversees the design, development and preparation of benefits related
reports (e.g., benefit metrics, flexible spending, participation analysis,
benefit costs)

| Type | Subject | Activity | Qualifiers |
|---|---|---|---|
| Primary | design, development | Oversees | Subject-Qualifier: |
| | and preparation of | | e.g., benefit metrics, |
| | benefits related | | flexible spending, |
| | reports | | participation |
| | | | analysis, benefit |
| | | | costs |

“e.g., benefit metrics . . . ” lists various examples of benefits related reports therefore, it should be annotated as a subject-qualifier. This requirement also contains an example of an indirect activity. Requirements that have a task as their subject are called indirect activities. Most management and coordination activities usually fall in this category. The ask in such requirements is not doing the task identified by the subject but rather being involved in the task in an indirect way through overseeing, coordinating or managing it. For instance, this requirement does not require that the employee design, develop or prepare benefits related reports. It only requires that the employee oversee others who are involved in such activities. As a result, the subject of this requirement is in turn another activity, e.g., “Design, development and preparation.” Consider another example of an indirect activity:

### Example 2.4

Assists the Manager of the department in the maintenance and
expansion of existing borrower and referral source relationships as
well as business development of new points of contact

| Type | Subject | Activity | Qualifiers |
|---|---|---|---|
| Primary | maintenance and | Assists | Person: |
| | expansion of | | Manager of the |
| | existing borrower | | department |
| | and referral source | | |
| | relationships as well | | |
| | as business | | |
| | development of new | | |
| | points of contact | | |

This requirement is a more complicated example of an indirect activity, as it includes a compound indirect activity acting on a compound subject, followed by a third indirect activity (composed of a nominalized verb), acting on a third subject. The subject in this case will be the entire compound phrase. Annotating the third task, “business development of new points of contact” as an independent entity is incorrect, as the word “assist” still applies to it. The software will be responsible for splitting the compound subject into two indirect activities. Consider another Guideline 1 example, this one consisting of two entities:

### Example 2.5

Field research to improve understanding of General Practitioner
Customers, with particular attention to utilization drivers

| Type | Subject | Activity | Qualifiers |
|---|---|---|---|
| Primary | | Field research | |
| Subordinate | understanding of | improve | Subject-Qualifier: |
| | General Practitioner | | with particular |
| | Customers | | attention to |
| | | | utilization drivers |

These are challenging requirements in many ways. To begin, “field research” is the rare example of a subject preceding an activity that is still annotated as an activity. This will be discussed in more detail later in the section, however, it is clear in this context that “field research” is an activity, not a “thing,” and therefore the system annotates it as an activity. For the subordinate entity, “with particular attention to utilization drivers” is a prepositional phrase containing a specific example of “General Practitioner Customers,” and as such should be annotated as a subject-qualifier.

Guideline 2 concerns prepositional phrases following the subject that involve person entities (though not person entities that should be annotated as the person field, which precede the subject, and will be discussed in a later section). Consider the following Guideline 2 example:

### Example 2.6

Conduct survey/analysis of current system and usage of PRIMA from
existing users

| Type | Subject | Activity | Qualifiers |
|---|---|---|---|
| Primary | current system and | Conduct | Subject-Qualifier: |
| | usage of PRIMA | survey/analysis | from existing users |

Example 2.6 is an interesting requirement in that it contains a compound activity-phrase, as “conduct survey” and “conduct analysis” are consistent with the meanings “survey” and “analyze,” and the activity-phrase is acting on a separate subject, “current system, and usage of PRIMA.” For Example 2.6, “from existing users,” is not necessary to create a meaningful subject, and should be annotated as the subject-qualifier. Occasionally, this guideline must be broken in order to create meaningful subjects. Consider the following examples:

### Example 2.7

Manage technical and troubleshooting relations with licensee

| Type | Subject | Activity | Qualifiers |
|---|---|---|---|
| Primary | technical and | Manage | Subject-Qualifier: |
| | troubleshooting | | with licensee |
| | relations | | |

For Example 2.7, the preceding qualifiers make the subject meaningful, and “with licensee” can be annotated as the subject-qualifier.

### Example 2.8

Manage relations with licensee

| Type | Subject | Activity | Qualifiers |
|---|---|---|---|
| Primary | relations with | Manage | |
| | licensee | | |

However, for Example 2.8, “with licensee” needs to be annotated with the subject, in order for it to meaningful. Consider the following example:

### Example 2.9

Acts as consultant to HR

| Type | Subject | Activity | Qualifiers |
|---|---|---|---|
| Primary | consultant to HR | Acts as | |

Example 2.9 also contains a prepositional phrase with a person entity (“HR”); however, it must be included with the subject in order for it to be meaningful.

Guideline 3 holds that multiple prepositional phrases not all be annotated with the subject: only those necessary for the subject to be meaningful. Occasionally, including a single prepositional phrase is necessary to create a meaningful subject. It would be rare for there to be two prepositional phrases necessary to create a meaningful subject. Consider the following Guideline 3 example:

### Example 2.10

Reviews proposals of analysts in various regional branches

| Type | Subject | Activity | Qualifiers |
|---|---|---|---|
| Primary | proposals of | Reviews | Subject-Qualifier: |
| | analysts | | in various regional |
| | | | branches |

For Example 2.10, there are two prepositional phrases following the activity. The first, “of analysts” should be annotated as part of the subject for it to be meaningful. The second, “in various regional branches,” should be annotated as the subject-qualifier.

### Example 2.11

Develop and elicit requirements of reports, processes, and
departmental and corporate projects that are more complex
in nature as requested by internal/external customers

| Type | Subject | Activity | Qualifiers |
|---|---|---|---|
| Primary | requirements of | Develop and elicit | Subject-Qualifier: |
| | reports, processes, | | that are more |
| | and departmental | | complex in nature |
| | and corporate | | |
| | projects | | |

For Example 2.11, “of reports . . . ” is necessary for “requirements” to be a meaningful subject. However, “that are more complex in nature,” the second prepositional phrase, is not necessary to create a meaningful subject and should be annotated as the subject-qualifier. Note that “as requested by internal/external customers” has not been annotated. This phrase is not meaningful for the individual who is seeking information on what KSA's he must develop/acquire, and therefore, the system does not annotate it (though still include it with the text). Meaningless phrases will be discussed in a later section.

It is important to remember that, for many requirements, no prepositional phrase need be annotated with the subject for it to be meaningful. This guideline is not suggesting that the first prepositional phrase always be annotated, but that generally, multiple prepositional phrases are not necessary to create a meaningful subject. However, there are occasionally requirements that do necessitate it. Consider the following example:

### Example 2.12

Elicit and document requirements for changes to business processes,
policies, information, and information systems for medium
business problems

| Type | Subject | Activity | Qualifiers |
|---|---|---|---|
| Primary | requirements for | Elicit and document | Subject-Qualifier: |
| | changes to business | | for medium |
| | processes, policies, | | business problems |
| | information, and | | |
| | information systems | | |

For this requirement, the system finds three prepositional phrases. The direct subject the individual is eliciting and documenting is “requirements.” However, for the subject to be meaningful here, the system must also annotate the prepositional phrase “for changes” and the prepositional phrase “to business processes, policies, information, and information systems.” This is the rare example of a requirement which does necessitate that two prepositional phrases be annotated with the subject for it to be meaningful: “requirements for changes” is not a meaningful subject in and of itself, therefore, “to business . . . ” must also be annotated. However, the system can annotate “for medium business problems” as a subject-qualifier.

Guideline 4 (stipulating that all phrases in parentheses following the subject be annotated as the subject-qualifier) is quite straightforward. Parentheses are used to include content that departs from the flow of the text, and as such, these “departures” should always be annotated as subject-qualifiers. However, in the instance that a parenthetical is used to share an abbreviation for the subject, or occurs in the midst of a subject, it must be annotated as part of the subject. Consider the following example:

### Example 2.13

Active involvement in account management (including budget analysis)
and creation of marketing campaigns

| Type | Subject | Activity | Qualifiers |
|---|---|---|---|
| Primary | account | Active involvement | |
| | management | in | |
| | (including budget | | |
| | analysis) and | | |
| | creation of | | |
| | marketing | | |
| | campaigns | | |

This requirement is another example of a compound indirect activity, in which the subject consists of tasks the individual must be “involved in.” The compound subject for this requirement consists of “account management” and “creation of marketing campaigns.” Though there is a parentheses containing a subject-qualifier for the first subject “(including budget analysis),” it should still be annotated with the subject. On the rare instances that a subject-qualifier is embedded within a subject (with or without parentheses), it must be annotated as part of the subject, as the entity model does not allow for multiple subject fields, nor does it allow a single subject to be discontinuous. When a qualifier appears in the middle of a subject, it must simply be annotated as part of the subject. Consider a similar example, without parentheses:

### Example 2.14

Ensure all support documentation, both prepared and submitted,
are in compliance and retained in accordance with the company's
records retention policy

| Type | Subject | Activity | Qualifiers |
|---|---|---|---|
| Primary | all support | Ensures | |
| | documentation, both | | |
| | prepared and | | |
| | submitted, are in | | |
| | compliance and | | |
| | retained in | | |
| | accordance with the | | |
| | company's records | | |
| | retention policy | | |

In this requirement, “all support documentation . . . are in compliance and retained in accordance with the company's records retention policy” is a single subject, therefore, “both prepared and submitted” must be annotated with the subject. This is solely because of its awkward context mid-subject. Were “both prepared and submitted” to be at the end of the requirement, it would be annotated as a subject-qualifier.

Guideline 5 largely is understood. It is evident that, when annotating entities such as “communication skills,” “negotiation abilities,” “budget analysis experience,” etc., that any prepositional phrase that follows these nouns should not be included with the subject. For the subject to be coherent and meaningful it should end at abilities/skills/experience: anything that follows is a subject-qualifier (or in some instances a separate entity). This guideline will likely be used infrequently, as phrases of this nature are rare. Consider the following Guideline 5 examples:

### Example 2.15

Quantitative skills such as statistics and data analysis

| Type | Subject | Activity | Qualifiers |
|---|---|---|---|
| Primary | Quantitative skills | | Subject-Qualifier: |
| | | | such as statistics and |
| | | | data analysis |

### Example 2.16

P&L experience where objectives were delivered consistently over time

| Type | Subject | Activity | Qualifiers |
|---|---|---|---|
| Primary | P&L experience | | Subject-Qualifier: |
| | | | where objectives |
| | | | were delivered |
| | | | consistently over |
| | | | time |

### Example 2.17

Strong analytical skills for business analysis

| Type | Subject | Activity | Qualifiers |
|---|---|---|---|
| Primary | Strong analytical | | Subject-Qualifier: |
| | skills | | for business analysis |

The prepositional phrases in the above examples qualify the skills and experience needed, and as such should be annotated as subject-qualifiers. Example 2.17 also serves as a good example of Guideline 6, which states that prepositional phrases that answer the “why” question, but do not qualify as subordinates, be annotated as subject-qualifiers. The qualifications of a subordinate requirement will be discussed in depth in a later section, however, note that “for business analysis” is the reason “Strong analytical skills” are needed—the “why.” However, it does not qualify as a complete subordinate requirement, and must therefore, be annotated as a subject-qualifier.

The following are general examples of when prepositional phrases are appropriate to include with the subject:

### Example 2.18

Analyze trade-offs between display performance,
manufacturability, and cost

| Type | Subject | Activity | Qualifiers |
|---|---|---|---|
| Primary | trade-offs between | Analyze | |
| | display | | |
| | performance, | | |
| | manufacturability, | | |
| | and cost | | |

### Example 2.19

Develop best practices for instrumentation and experimentation

| Type | Subject | Activity | Qualifiers |
|---|---|---|---|
| Primary | best practices for | Develop | |
| | instrumentation and | | |
| | experimentation | | |

On their own, “trade-offs” and “best practices” do not constitute meaningful subjects, therefore, it is necessary to annotate the prepositional phrases with the subject. Consider the following example:

### Example 2.20

Evaluate various display mechanical structures for future projects

| Type | Subject | Activity | Qualifiers |
|---|---|---|---|
| Primary | various display | Evaluate | Subject-Qualifier: |
| | mechanical | | for future projects |
| | structures | | |

In Example 2.20, the preceding qualifiers for “structures” make it meaningful enough that the system does not need to annotate “for future projects” with the subject. However, if the requirement were simply “Evaluate structures . . . ,” the system would annotate “for future projects” with the subject, to make it meaningful.

Occasionally a qualifier (either a subject or activity-qualifier) may have the structure of a complete requirement, or may even consist of several complete requirements. Regardless of a qualifier's ability to stand on its own, it should still be annotated as a qualifier. Consider the following requirement:

### Example 2.21

Assist in the full life cycle of development including: Eliciting
requirements using interviews, document analysis, requirements
workshops, business process descriptions, use cases, scenarios,
business analysis, task and workflow analysis

| Type | Subject | Activity | Qualifiers |
|---|---|---|---|
| Primary | full life cycle of | Assist in | Subject-Qualifier: |
| | development | | including: Eliciting |
| | | | requirements using |
| | | | interviews, |
| | | | document analysis, |
| | | | requirements |
| | | | workshops, business |
| | | | process |
| | | | descriptions, use |
| | | | cases, scenarios, |
| | | | business analysis, |
| | | | task and workflow |
| | | | analysis. |

In Example 2.21, “including: Eliciting requirements . . . ” is a standard subject-qualifier that lists an example component of the subject. However, its length and ability to function as a standalone requirement might confuse the issue. However, it should still be annotated as a subject-qualifier. Regardless of how long a qualifier may be, or how many full requirements it is comprised of, it should be annotated as a qualifier. There is no cut-off point. When annotating in accordance to this guideline feels illogical (i.e., a paragraph-long subject-qualifier consisting of several requirements), it should still be followed, as instances of this are rare, and annotating according to logic and against guidelines in this respect would create more problems.

It is possible to have requirements with just a subject and no activity. The following examples illustrate:

### Example 2.22

Strong attention in detail

| Type | Subject | Activity | Qualifiers |
|---|---|---|---|
| Primary | Strong attention to | | |
| | detail | | |

### Example 2.23

Customer service orientation and professionalism

| | | | |
|---|---|---|---|
| Type | Subject | Activity | Qualifiers |

| | |
|---|---|
| Primary | Customer service |
| | orientation and |
| | professionalism |

For example 2.23, the subject is a compound subject. Occasionally, a sentence may consist solely of a list of subjects. These should not always be annotated together. Consider the following sentence: “SDLC (software development life-cycle), TeamTrack, SharePoint, Ability to go through CNR (change notification request) process.” The first three subjects listed have no connection to each other: they are each tools, which the system must infer that the position requires experience with. The correct annotation here is to annotate “SDLC,” “TeamTrack,” and “SharePoint” separately, as standalone requirements consisting of subjects. “Ability to go through . . . ” would also be annotated separately.

When a sentence contains a list of subjects (with no activity to connect them), they should only be annotated together as a compound subject if there is a connective word between them, regardless of the nature of the connector. Example 2.23 is one example: “orientation” and “professionalism” are connected through the qualifier “customer service.” Consider the following examples:

### Example 2.24

Experience in consumer marketing and campaign implementation

| | | | |
|---|---|---|---|
| Type | Subject | Activity | Qualifiers |

| | | |
|---|---|---|
| Primary | Consumer | Level: |
| | marketing and | Experience in |
| | campaign | |
| | implementation | |

In this example, the connection between “consumer marketing” and “campaign implementation” is the level qualifier, “Experience in.”

### Example 2.25

Excellent verbal and oral communication skills

| | | | |
|---|---|---|---|
| Type | Subject | Activity | Qualifiers |

| | |
|---|---|
| Primary | Excellent verbal and |
| | oral communication |
| | skills |

In this example, “verbal” and “oral communication” shares the noun “skills” and the adjective “excellent.”

Occasionally, a subject such as “Communication skills” will be followed by a “with” prepositional phrase consisting of another set of skills. Sometimes, the second set of skills qualifies the first set and functions as a subject-qualifier. However, occasionally the second set of skills has no bearing on the first set, despite the “with.” In those instances, it appears that “with” was written with an intent equivalent to “and.” However, when this occurs, the system cannot judge “with” to be an equivalent of “and.” The system must judge according to the meaning bestowed by the word “with,” and annotate a subject-qualifier. Consider the following requirements:

### Example 2.26

Communication skills with presentation abilities

| | | | |
|---|---|---|---|
| Type | Subject | Activity | Qualifiers |

| | | |
|---|---|---|
| Primary | Communication | Subject-Qualifier: |
| | skills | with presentation |
| | | abilities |

For Example 2.26, “with presentation abilities” is a logical subject-qualifier. “Presentation abilities” is a component of “Communication skills,” and qualifies the subject. Conversely, consider:

### Example 2.27

Communication skills with project management skills

| | | | |
|---|---|---|---|
| Type | Subject | Activity | Qualifiers |

| | | |
|---|---|---|
| Primary | Communication | Subject-Qualifier: |
| | skills | with project |
| | | management skills |

Here, “project management skills” has no bearing on, or connection to, “Communication skills.” As such, it does not really make sense as a subject-qualifier. It is clearly the intent that it be taken as a second subject. However, the system must still annotate it as a subject-qualifier. The reason for this is that the algorithm does not have the real-world knowledge to know that “presentation abilities” bears on “Communication skills,” whereas “project management skills” does not. It would not be able to understand why the system would annotate Example 2.26 with a subject-qualifier and Example 2.27 as two separate entities. Therefore, the system cannot annotate differently for the above two examples, as the algorithm cannot conceivably learn our logic in doing so. The system must therefore obey the signifier of “with,” and annotate a subject-qualifier for both.

This logic extends to other prepositional phrases that may be “posing” as activity or subject-qualifiers, due to poorly phrased requirements. One may find a requirement with an “including” prepositional phrase following the subject which the annotator may discern has no bearing on the subject, and was clearly meant to be taken as a separate entity. However, that discernment is the result of real-world knowledge, and as such, the system cannot annotate according to it, as the algorithm cannot learn it. The system must therefore annotate according to the words actually on the page. If a requirement is written with an “including” prepositional phrase following the subject, the phrase must be annotated as befits an “including” phrase that follows the subject—as a subject-qualifier, despite how little it may actually qualify the subject.

When annotating a requirement consisting solely of a subject followed by a nominalized verb (e.g., “systems analysis,” “product documentation,” “requirements gathering”), it should be annotated as a subject phrase in entirety. However, it is important to remember that context is very important. Consider the following set of requirements:

### Example 2.28

Experience in project management

| | | | |
|---|---|---|---|
| Type | Subject | Activity | Qualifiers |

| | | |
|---|---|---|
| Primary | project management | Level: |
| | | Experience in |

### Example 2.29

Project management of various projects and activities

| Type | Subject | Activity | Qualifiers |
|---|---|---|---|
| Primary | various projects and | Project management | |
| | activities | of | |

In Example 2.28, “project management” is taken as a subject, a “thing.” In Example 2.29, it is clearly a nominalized-verb activity, acting on the secondary subject of “various projects and activities.” With a similar logic that allows activity-phrase annotations if they are acting on a second subject, subject/nominalized verb-phrases are allowable if they are acting upon a second subject.

Identifying Person

The person field answers the question of “whom” in relation to the activity. This can be in the context of “with whom,” “for whom,” etc. It is important that the person field be annotated with its correct context and meaning to the overall requirement intact. To ensure this, the following guidelines specify when and where a person field should be annotated:

The person field should be annotated whenever it precedes the subject

The person field should be annotated when a requirement consists only of an activity and person entity, and that person entity is not in the context of a direct subject to the activity.

A subject should be annotated when a person entity is the direct subject of an activity (except when the direct subject-person entity precedes an indirect activity, in which case it should be annotated as the person field).

A subject-qualifier should be annotated when a prepositional phrase containing a person entity follows the subject (except when that prepositional phrase is necessary to include with the subject, in order for it to be meaningful).

The rationale for annotating person entities that follow the subject as subject-qualifiers is that it allows the system to maintain the context of the person entity to the requirement. The system does not allow prepositions to be annotated with subjects or person entities. There are many non-equivalent contexts in which a person entity may be involved in an activity or subject. For that meaning to always be clear, the system must annotate person entities following the subject as subject-qualifiers. Person entities preceding the subject do not have this difficulty, as trailing prepositions in activities and activity-qualifiers are annotated. The following examples illustrate person field annotations:

### Example 3.1

Works with game designers to create intuitive designs for game UIs

| Type | Subject | Actvity | Qualifiers |
|---|---|---|---|
| Primary | create intuitive | Works with | Person: |
| | designs for game | | game designers |
| | UIs | | |

### Example 3.2

Manage the development team to ensure
that a quality product is released on time

| Type | Subject | Activity | Qualifiers |
|---|---|---|---|
| Primary | ensure that a quality | Manage | Person: |
| | product is released | | development team |
| | on time | | |

In Examples 3.1 and 3.2, both include indirect activities as the subjects, which necessitates that the person entity be annotated as the person field.

When annotating a requirement that consists simply of an activity and person entity that is not in the context of a direct subject to the activity, the person entity should still be annotated as the person field. Consider the following examples:

### Example 3.3

Coordinating with SCB departments

| | | | |
|---|---|---|---|
| Type | Subject | Activity | Qualifiers |

| | | |
|---|---|---|
| Primary | Coordinating with | Person: |
| | | SCB departments |

### Example 3.4

Underwriting for the Renewable Energy Group

| | | | |
|---|---|---|---|
| Type | Subject | Activity | Qualifiers |

| | | |
|---|---|---|
| Primary | Underwriting for | Person: |
| | | Renewable Energy |
| | | Group |

Consider the following requirements, in which person entities are the direct subject of the action, and as such, should be annotated as the subjects:

### Example 3.5

Motivate sales professionals

| | | | |
|---|---|---|---|
| Type | Subject | Activity | Qualifiers |

| | | |
|---|---|---|
| Primary | sales professionals | Motivate |

### Example 3.6

Assist the crime program

| | | | |
|---|---|---|---|
| Type | Subject | Activity | Qualifiers |

| | | |
|---|---|---|
| Primary | crime program | Assist |

### Example 3.7

Technical lead of project teams

| | | | |
|---|---|---|---|
| Type | Subject | Activity | Qualifiers |

| | | |
|---|---|---|
| Primary | project teams | Technical lead of |

Now, if the above requirements preceded an indirect activity, these person entities would no longer be annotated as subjects. Consider the following requirements:

### Example 3.8

Assist the crime program to implement new procedures

| Type | Subject | Activity | Qualifiers |
|---|---|---|---|
| Primary | implement new | Assist | Person: |
| | procedures | | crime program |

### Example 3.9

Technical lead of project teams to develop marketing strategies

| Type | Subject | Activity | Qualifiers |
|---|---|---|---|
| Primary | develop marketing | Technical lead of | Person: |
| | strategies | | project teams |

Consider the following requirement which involves an activity-phrase:

### Example 3.10

Provides guidance on a continuous basis to team members in the areas
of project lifecycle, operating procedures, processes and practices

| Type | Subject | Activity | Qualifiers |
|---|---|---|---|
| Primary | areas of project | Provide guidance | Activity-Qualifier: on |
| | lifecycle, operating | | a continuous basis to |
| | procedures, | | Person: team members |
| | processes and | | |
| | practices | | |

For Example 3.10, the system would annotate an activity-phrase, as “provide guidance” is acting on a separate subject (“areas of project lifecycle . . . ”). As such, “team members” is preceding the subject, and therefore should be annotated as the person field. The following is an example of when a person entity should be annotated as a subject-qualifier:

### Example 3.11

Conduct financial training sessions for team members

| Type | Subject | Activity | Qualifiers |
|---|---|---|---|
| Primary | financial training | Conduct | Subject-Qualifier: for team |
| | sessions | | members |

For Example 3.11, “financial training sessions” is a meaningful subject, necessitating that “for team members” be annotated as a subject-qualifier. If the requirement read as “Conduct sessions for team members,” “for team members” would be included with the subject, in order for it to be meaningful.

Identifying Level Qualifiers

When considering what to annotate as a level qualifier, context is very important. Consider the following examples:

### Example 4.1

Experience in project management

| | | | |
|---|---|---|---|
| Type | Subject | Activity | Qualifiers |

| | | |
|---|---|---|
| Primary | project management | Level: Experience in |

### Example 4.2

Project management experience

| | | | |
|---|---|---|---|
| Type | Subject | Activity | Qualifiers |

| | |
|---|---|
| Primary | Project management |
| | Experience |

The location of the word “experience” within the requirement determines whether it is to be annotated as a level, or as part of the subject. When “experience” follows the subject, it should be annotated with the subject. Consider the following sets of examples:

### Example 4.3

Skilled in analyzing budgets

| Type | Subject | Activity | Qualifiers |
|---|---|---|---|
| Primary | budgets | analyzing | Level: Skilled in |

### Example 4.4

Budget analysis skills

| | | | |
|---|---|---|---|
| Type | Subject | Activity | Qualifiers |

| | |
|---|---|
| Primary | Budget analysis |
| | skills |

### Example 4.5

Proficient in negotiating transactions

| Type | Subject | Activity | Qualifiers |
|---|---|---|---|
| Primary | transactions | negotiating | Level: Proficient in |

### Example 4.6

Proficient negotiation skills

| | | | |
|---|---|---|---|
| Type | Subject | Activity | Qualifiers |

| | |
|---|---|
| Primary | Proficient |
| | negotiation skills |

As illustrated by the above examples, terms such as “experience,” “skills,” or “abilities” are annotated with the subject. When they are in the context of “Experience in . . . ” or “Skilled in . . . ,” they are annotated as level qualifiers. Similarly, adjectives that precede the subject such as “excellent,” “strong,” “skilled,” etc. are annotated with the subject. However, in the context of “Strong in . . . ” or “Proficient in . . . ,” they are annotated as level qualifiers. Notice that each of these is followed by the relevant preposition: when annotating level qualifiers, if there is an attached preposition of “to,” “of,” “in,” etc., annotate it with the level qualifier. Consider the example:

### Example 4.7

Some familiarity with real estate and real
estate related documentation preferred

| | | | |
|---|---|---|---|
| Type | Subject | Activity | Qualifiers |

| | | |
|---|---|---|
| Primary | real estate and real | Level: Some familiarity |
| | estate related | with |
| | documentation | Required: preferred |

In this requirement “Some familiarity with” is the level of understanding sought with the subject. “Preferred” is annotated as a required qualifier.

Occasionally, more complex level qualifiers are appropriate, and in line with intent. Consider the following requirement:

### Example 4.8

Related industry experience in system interface design concepts

| | | | |
|---|---|---|---|
| Type | Subject | Activity | Qualifiers |

| | | |
|---|---|---|
| Primary | system interface | Level: Related industry |
| | design concepts | experience in |

This is a slightly complicated requirement, in that “related industry experience” could be interpreted as the subject. There are numerous examples of subjects that consist of the same, or very similar, text. However, it is essential always to analyze phrases in context. And in the context of this requirement, “Related industry experience” is clearly not the subject—the subject here is “system interface design concepts,” and “Related industry experience” is merely the level the employer expects the individual to have in this subject. While it is important always to analyze context, it is equally important to be wary of looking at certain prepositions and lead-ins as automatic signifiers of a level qualifier, when it is in fact not appropriate. Consider the following requirement:

### Example 4.9

Strong interpersonal and collaboration skills in
team-based end-user and developer-facing projects

| | | | |
|---|---|---|---|
| Type | Subject | Activity | Qualifiers |

| | | |
|---|---|---|
| Primary | Strong interpersonal | Subject-Qualifier: in team-based |
| | and collaboration | end-user and developer-facing |
| | skills | projects |

For this requirement, if one were to infer that the combination of the preposition “in,” and the level qualifier terminology of “skills,” meant that “Strong interpersonal and collaboration skills” should be annotated as the level qualifier for this requirement, they would be mistaken. One must always close-read requirements, and here, it is clear that “Strong interpersonal and collaboration skills” is the subject, and “in team-based . . . ” is a qualifier for that subject.

Identifying Required and Years Qualifier

The required qualifier pinpoints the degree of importance or necessity attached to the job requirement. Terms that should be annotated as a required qualifier extend beyond simply “required.” Terms such as “preferred,” “ideal” or “must have” should also be annotated as required qualifiers, as they function as points on a scale of escalating importance for a job requirement (i.e., an educational degree that is “required” is of more importance than one that is “preferred”). Consider the following example:

### Example 5.1

Must have a Bachelor's Degree in Accounting

| | | | |
|---|---|---|---|
| Type | Subject | Activity | Qualifiers |

| | | |
|---|---|---|
| Education | Accounting | Level: Bachelor's Degree |
| | | Required: must have |

In this example, “must have” is equivalent to stating that a Bachelor's Degree in Accounting is required.

Occasionally, one may find a sentence that lists multiple job requirements, as well as a required qualifier that is clearly intended to reach across and apply to each of the requirements. However, it should only be annotated with the nearest entity. Consider the following sentence: “Strong problem solving skills and excellent judgment skills required.” Due to the construction of this sentence, it is clear that both “strong problem solving skills” and “excellent judgment skills” are required for the role. However, as “strong problem solving skills” and “excellent judgment skills” are two distinct requirements that must be annotated separately, “required” can only be associated with its closest entity: “excellent judgment skills.” “Strong problem solving skills” would be annotated separately, with no required qualifier included.

It is important to recognize where required qualifiers are inappropriate, as well. Consider the following set of requirements:

### Example 5.2

Must possess good interviewing skills

| | | | |
|---|---|---|---|
| Type | Subject | Activity | Qualifiers |

| | | |
|---|---|---|
| Primary | good interviewing | Required: Must possess |
| | skills | |

### Example 5.3

Possess project management skills

| | | | |
|---|---|---|---|
| Type | Subject | Activity | Qualifiers |

| | |
|---|---|
| Primary | project management |
| | skills |

Without the “must” preceding “possess,” “possess” on its own is meaningless and should not be annotated as a required qualifier or activity. However, the algorithm automatically extracts verbs as activities, unless it learns that a specific verb is considered meaningless. This being the case, verbs such as “possess” and “have” should always be included in text when they occur, so the algorithm may have the opportunity to learn that they are not meaningful verbs.

With required qualifiers (as with many other fields), deciphering intent and considering context are key to what should and should not be annotated. Consider the following two examples: “This position requires the facilitation of work sessions” or “must facilitate work sessions.” The “requires” and “must” here simply indicate that the employee will need to do such work. They do not state a qualification or skill that the employer is expecting from the candidate. The algorithm automatically infers that all annotated tasks are required. Therefore, the system would include this language in text, but not annotate a required qualifier for either requirement.

While the algorithm can infer that all tasks are required, it may not always be able to infer if a task is considered critical to the role. Consider the following requirement:

### Example 5.4

“Responsible for working with leadership to identify and
quantify business process improvements along with system
improvements through the use of technology is critical”

| Type | Subject | Activity | Qualifiers |
|---|---|---|---|
| Primary | identify and | working with | Person: |
| | quantify business | | leadership |
| | process | | Activity-Qualifier: |
| | improvements along | | through the use of |
| | with system | | technology |
| | improvements | | Required: |
| | | | Critical |

With the above requirement, the system would make an exception to the guideline governing required qualifiers and tasks. The system could not infer that this task would be critical, and therefore, the system would annotate a required qualifier for this task. Similarly, required qualifiers for tasks such as “top priority” would be annotated: any required qualifier that elevates the task to a level above required is considered an exception to this guideline, and should be annotated as a required qualifier.

The year's qualifier is fairly simple and straightforward. Consider the following example:

### Example 5.5

3+ years' experience working with financial and/or
Manufacturing systems preferred

| Type | Subject | Activity | Qualifiers |
|---|---|---|---|
| Primary | financial and/or | working with | Years: |
| | Manufacturing | | 3+ years |
| | systems | | Level: |
| | | | experience |
| | | | Required: |
| | | | preferred |

Occasionally a requirement may read, “minimum of 8 years' experience in financial analysis.” For these requirements, “minimum of” should be annotated with the year's qualifier, as “minimum of” is not qualifying the overall level, but the year's requirement. Consider the following requirement:

### Example 5.6

Understanding of and minimum 1-2 years of
solid experience working as a BA

| | | | |
|---|---|---|---|
| Type | Subject | Activity | Qualifiers |

| | | |
|---|---|---|
| Primary | Working as | Level: |
| | | Understanding of |
| | | and minimum 1-2 |
| | | years of solid |
| | | experience |

For Example 5.6, the years' qualifier is embedded between two level qualifiers. As the system cannot allow a discontinuous level field annotation, the system must annotate the years' qualifier with the level qualifier, similarly to subject-qualifiers occurring in the midst of a subject.

Identifying Certification, License and Education Entities

Certification and license requirements will often necessitate using a field that is not used for any other requirement: the name field. If the name of a certification or license is provided in a requirement, it is annotated under the name field. Consider the following example:

### Example 6.1

CCBA certification (Certification of Competency in
Business Analysis)

| | | | |
|---|---|---|---|
| Type | Subject | Activity | Qualifiers |

| | |
|---|---|
| Certification | Name: |
| | CCBA certification |
| | (Certification of |
| | Competency in |
| | Business Analysis) |

Consider the following unusual certification requirement:

### Example 6.2

Progress towards ASA/AFA designation

| | | | |
|---|---|---|---|
| Type | Subject | Activity | Qualifiers |

| | |
|---|---|
| Certification | Name: |
| | ASA/AFA |
| | designation |
| | Required: |
| | Progress towards |

This is an instance of a requirement in which, in context, it is necessary to warp our understanding of required fields (which generally do not contain prepositions). But for this requirement, it is needed in order to capture intent, as “Progress” does not really contain the full meaning expressed in the requirement.

When annotating education entities, a sentence containing multiple education requirements (i.e., alternate degrees) should be annotated following the same guidelines for compound activities: if the degree levels share the same subject, then they should be annotated together as one level field.

If they are each listed with individual subjects, they should each be annotated as independent education entities. If several education entities are listed with one required qualifier, they should still be annotated separately, with the required field associated with the education entity to which it is closest.

The approach to education entities is to make the subject as simple and straightforward as possible. To this end, if a requirement were to read, “BA in Communications or related field,” “or related field” would be annotated as the subject-qualifier, not the subject. Consider the following example:

### Example 6.3

Bachelor's degree in Accounting or related field (e.g. finance)

| | | | |
|---|---|---|---|
| Type | Subject | Activity | Qualifiers |

| | | |
|---|---|---|
| Education | Accounting | Level: |
| | | Bachelor's degree |
| | | Subject-Qualifier: |
| | | or related field (e.g. |
| | | Finance) |

In Example 6.3, only “Accounting” has been annotated as the subject. The rest is annotated as the subject-qualifier. Consider the following requirement:

### Example 6.4

BA in Accounting with quantitative skills

| | | | |
|---|---|---|---|
| Type | Subject | Activity | Qualifiers |

| | | |
|---|---|---|
| Education | Accounting | Level: |
| | | BA |
| | | Subject-Qualifier: |
| | | with quantitative |
| | | skills |

Here, “with quantitative skills” is further qualifying the subject of “Accounting,” and as such would be annotated as a subject-qualifier. Consider a similar requirement:

### Example 6.5

BA with quantitative skills

| | | | |
|---|---|---|---|
| Type | Subject | Activity | Qualifiers |

| | | |
|---|---|---|
| Education | quantitative skills | Level: |
| | | BA |

Without the subject of “Accounting,” the system would annotate “quantitative skills” as the subject. Consider the following requirement:

### Example 6.6

B.S. or M.S. Engineering (Chemical or Mechanical preferred)

| | | | |
|---|---|---|---|
| Type | Subject | Activity | Qualifiers |

| | | |
|---|---|---|
| Education | Engineering | Level: |
| | | B.S. or M.S. |
| | | Subject-Qualifier: |
| | | Chemical or |
| | | Mechanical |
| | | preferred |

One might mistakenly consider “preferred” to be a required qualifier, but this is not stating that the entire degree is “preferred,” rather, it is stating that two specific topic areas within the subject are preferred.

For Example 6.6, a compound level of “B.S. or M.S.” is annotated. Education entities also allow more atypical compound level annotations. Consider the following example:

### Example 6.7

MBA or related experience required

| | | | |
|---|---|---|---|
| Type | Subject | Activity | Qualifiers |

| | |
|---|---|
| Education | Level: |
| | MBA or related |
| | experience |
| | Required: |
| | required |

As “or related experience” is posited as an equivalent, or alternative, to the educational qualification of an MBA, the simplest and most intuitive approach is to treat them as equivalent, and annotate a compound level. Though MBA provides both the level and subject of its degree, for the purposes of annotation, MBA may be annotated as a level, not a subject. However, consider the following requirement:

### Example 6.8

BS in Economics or related experience

| | | | |
|---|---|---|---|
| Type | Subject | Activity | Qualifiers |

| | | |
|---|---|---|
| Education | Economics | Level: |
| | | B.S. |
| | | Subject-Qualifier: |
| | | or related |
| | | experience |

Here, a subject, “Economics,” has been listed with the first level, “BS.” The system cannot annotate two levels, nor would the system annotate “Economics” with the two levels, and lose a meaningful subject. The system therefore annotate “or related experience” as a subject-qualifier in this scenario. This is similar to our approach on person entities: depending on their context within a requirement, the field they are annotated as varies. When a person entity precedes a subject, it is annotated as the person field, whereas, when a person entity follows a subject, it is annotated as a subject-qualifier. Similarly, “or equivalent experience” is annotated as a compound level when there is no subject, and as a subject-qualifier when there is a subject. The system would treat “with equivalent experience,” “or related degree,” etc., identically to this.

However, there is a distinction between how the system would treat “MBA with equivalent experience” and “MBA with quantitative skills,” as evidenced above. “Quantitative skills” forms an acceptable subject, as it is similar to a more traditional subject such as “Accounting,” but at the next level of detail (which is why it is generally a subject-qualifier). Conversely, “equivalent experience” does not make sense as a subject annotation, and must be annotated either as part of the level, or as the subject-qualifier.

Identifying Subordinate Requirements

All requirements discussed thus far are duties that an employee is expected to do (or KSAs they are expected to have) as part of their job. The system define such requirements as primary requirements. However, job descriptions can also contain subordinate requirements, or, non-primary requirements. Subordinate requirements are connected to primary requirements, and state the goal of the primary requirement by answering the question “Why.” Subordinate requirements typically appear as infinitive phrases (e.g., infinitive phrases may begin with the word “to” and are followed by a verb) in a job requirement, though it is important to note that not all infinitive phrases are subordinate requirements. Furthermore, there can be non-infinitive phrases that are subordinates. As long as a phrase has an activity and answers the “why” question, it can be annotated as a subordinate. Multiple subordinate entities within a sentence are also allowed, as there can be multiple goals to an action.

The following examples illustrate subordinate requirements:

### Example 7.1

Creates commodity-specific sourcing strategies to optimize
supplier base and total cost of ownership

| | | | |
|---|---|---|---|
| Type | Subject | Activity | Qualifiers |

| | | |
|---|---|---|
| Primary | commodity-specific | Creates |
| | sourcing strategies | |
| Subordinate | supplier base and | optimize |
| | total cost of | |
| | ownership | |

The primary task an employee is expected to do in this requirement is create commodity-specific sourcing strategies. The phrase “to optimize supplier base and total cost of ownership” defines the reason for creating commodity-specific sourcing strategies. An employee may not have to optimize the supplier base or the total cost-of-ownership. It is therefore a subordinate requirement.

The examples here are for motivating the challenges in consistently annotating job descriptions. The appendices illustrate many more fields and many more patterns for each field.

### Example 7.2

Reviews and evaluates accident reports to estimate the monetary
value of the company's casualty exposure

| | | | |
|---|---|---|---|
| Type | Subject | Activity | Qualifiers |

| | | |
|---|---|---|
| Primary | accident reports | Reviews and |
| | | evaluates |
| Subordinate | monetary value of | estimate |
| | the company's | |
| | casualty exposure | |

### Example 7.3

Develops strategies to achieve organizational goals

| | | | |
|---|---|---|---|
| Type | Subject | Activity | Qualifiers |

| | | |
|---|---|---|
| Primary | strategies | Develops |
| Subordinate | organizational goals | achieve |

These examples are similar to 7.1. The subordinate requirement only defines the goal of the primary requirement. By contrast, the following requirement does not define a subordinate requirement even though it contains an infinitive phrase:

### Example 7.4

Works with business unit subject matter experts to gather and
assess business requirements

| Type | Subject | Activity | Qualifiers |
|---|---|---|---|
| Primary | gather and assess | Works with | Person: |
| | business | | business unit subject |
| | requirements | | matter experts |

This is an indirect activity, and the subject is composed of the tasks, “gather and assess business requirements.”

When faced with a prepositional phrase that answers the “why” question of the primary requirement, it is important to ensure that the phrase also qualifies as a subordinate requirement. For a subordinate requirement to be annotated, in addition to stating the “goal” of the primary requirement, it must also consist of an activity. When a prepositional phrase answers the question of “why” for the primary requirement, but does not qualify as a subordinate requirement, it should be annotated as the subject-qualifier. Consider the following requirement:

### Example 7.5

Perform account analysis for budgetary purposes

| Type | Subject | Activity | Qualifiers |
|---|---|---|---|
| Primary | account analysis | Perform | Subject-Qualifier: |
| | | | for budgetary |
| | | | purposes |

In Example 7.5, the phrase annotated as a subject-qualifier does tell the system why the activity is being performed, however, it would not make sense as a subordinate entity, as it does not contain an activity.

Very occasionally, there are non-infinitive subordinate requirements. Consider the following example:

### Example 7.6

Analyze accounts with a goal of discerning potential budgetary issues

| Type | Subject | Activity | Qualifiers |
|---|---|---|---|
| Primary | accounts | Analyze | |
| Subordinate | potential budgetary | discerning | |
| | issues | | |

For Example 7.6, “discerning potential budgetary issues,” though not an infinitive, is the goal of the primary requirement, and it qualifies as a full subordinate entity. Therefore, it should be annotated as a subordinate entity. However, the system would not annotate “with a goal of . . . ” with either entity, but would include it with the text for the subordinate entity, as it functions as a kind of bridge leading into the subordinate entity. Many primary entities lead into subordinate entities by way of a bridge—a connective word or phrase that does not carry the meaning of either requirement, but connects the two. Such language should always be included in the text with either the primary or the subordinate entity. The following examples illustrate various kinds of connective text, and the entity it should be included with:

### Example 7.7

### Prepare One or More of the Deliverables Required to Build Business Requirement Documents

| | | | |
|---|---|---|---|
| Type | Subject | Activity | Qualifiers |

Prepare one or more of the deliverables required

| | | |
|---|---|---|
| Primary | one or more of the | Prepare |
| | deliverables | |

to build Business Requirement Documents

| | | |
|---|---|---|
| Subordinate | Business | build |
| | Requirement | |
| | documents | |

When the connective text qualifies a component of the primary requirement, it should be included with the primary requirement. Above, “required” describes the kind of deliverables the individual must prepare. A similar example of this type of connective bridge would be “necessary.” To be clear, despite that “required” is describing the subject of the primary entity, it should not be annotated as a subject-qualifier. Language bridges between primary and subordinate entities should only be included in text. Below is another example of this type of connector:

### Example 7.8

### Combination of Business Acumen and Technical Expertise Used to Develop High Quality and Measurable HR Metrics for Executive Level

| | | | |
|---|---|---|---|
| Type | Subject | Activity | Qualifiers |

Combination of business acumen and technical expertise used

| | |
|---|---|
| Primary | Combination of |
| | business acumen |
| | and technical |
| | expertise |

to develop high quality and measurable HR metrics for executive level

| | | | |
|---|---|---|---|
| Subordinate | high quality and | develop | Subject-Qualifier: |
| | measurable HR | | for executive level |
| | metrics | | |

The following examples are a different type of connector, which the system would include with the subordinate entity:

### Example 7.9

### Execute Data Gathering and Root Cause Analysis in Order to Develop Appropriate Process Control Changes

| | | | |
|---|---|---|---|
| Type | Subject | Activity | Qualifiers |

Execute data gathering and root cause analysis

| | | |
|---|---|---|
| Primary | data gathering and | Execute |
| | root cause analysis | |

in order to develop appropriate process control changes

| | | |
|---|---|---|
| Subordinate | appropriate process | develop |
| | control changes | |

This is perhaps the most common connector one will come across. It should always be included with the subordinate entity text, as it bears on the subordinate entity, not the primary entity (unlike Examples 7.7 & 7.8). Similarly, consider:

### Example 7.10

### Gather/Analyze/Document Business Requirements Leading to the Development of a Business Solution

| | | | |
|---|---|---|---|
| Type | Subject | Activity | Qualifiers |

Gather/analyze business requirements

| | | |
|---|---|---|
| Primary | business | Gather/analyze |
| | requirements | |

leading to the development of a business solution

| | | |
|---|---|---|
| Subordinate | business solution | development of |

Many subordinate entities will consist of a goal that involves other employees, i.e. the individual's action in the primary entity enables the team/another team member to perform another action. When this type of connector occurs, it should also be included with the subordinate entity. Consider the following example:

### Example 7.11

### Thorough Data Analysis Will Allow Team Members to Continually Improve Services Offered

| | | | |
|---|---|---|---|
| Type | Subject | Activity | Qualifiers |

Thorough data analysis

| | |
|---|---|
| Primary | Thorough data |
| | analysis |

will allow learn members to continually improve services offered

| | | |
|---|---|---|
| Subordinate | services offered | continually improve |

Example embodiments of the system would not include the person entities in the annotations here—the intended task is “continually improve . . . . ” All that precedes is connective language, which, being intrinsically connected to the subordinate entity task should be included with subordinate entity text.

Using Prepositions

The approach to prepositions is that they should always be annotated if they occur in the following contexts:

Before or after an activity-qualifier (e.g., “with limited supervision”).

Before a subject-qualifier (e.g., “including PowerPoint, Word”).

After an activity (e.g., “works with”).

After a level (e.g., “experience in”). The only exception to this guideline is when the level field is annotated for an education entity (e.g., no prepositions before or after “bachelor's degree”).

Prepositions should very rarely be used in the following field, and only when necessary:

Required field.

Prepositions should never be annotated before or after the following fields, regardless of any meaning it may add in context: subject, year's field, person field, and/or name field.

Headers

Generic headers such as “Educational Requirements” or “Duties” should not be annotated, nor included in text. However, meaningful headers (containing either a meaningful subject, activity, or both) should be annotated. When annotating these headers, they should be annotated with their proximal entity. The format one should follow in these rare instances is to annotate the header as the traditional requirement. For example, headers that are meaningful entities in their own right occur very rarely. When they do occur within a job description, it is likely that there will be multiple meaningful headers within that job description, as it is a style of writing. However, it is a rare occurrence, and most headers should not be annotated nor included with text. The proximal entity that succeeds it should then be annotated as its subject-qualifier. Consider the following examples:

### Example 8.1

Process Knowledge - Understands Citrix Customer Service processes

| | | | |
|---|---|---|---|
| Type | Subject | Activity | Qualifiers |

| | | |
|---|---|---|
| Primary | Process Knowledge | Subject-Qualifier: |
| | | Understands Citrix |
| | | Customer Service |
| | | processes |

It is important to note that this requirement was preceded by yet another header, “Functional Requirements.” However, that falls in the category of the more traditional, generic header, which is ignored.

### Example 8.2

(Stage 1 ) Orchestrating Resources - Develops
collaborative, engaged, focused teams of resources

| Type | Subject | Activity | Qualifiers |
|---|---|---|---|
| Primary | Resources | Orchestrating | Subject-Qualifier: |
| | | | Develops |
| | | | collaborative, |
| | | | engaged, focused |
| | | | teams of resources |

Here, one might consider “Develops . . . ” to be more appropriate as an activity-qualifier than a subject-qualifier. However, the system always annotate the proximal entity that follows the header as a subject-qualifier. As meaningful headers occur rarely, they must follow a consistent formula of annotation. And as annotating a header with the following requirement as its qualifier inevitably subverts the normal formatting of an activity or subject-qualifier regardless, the system must aim for consistency here.

Occasionally, one might see a header/requirement, which lists a subject, followed by a level. When this occurs, it is allowable to annotate it, despite its inverse structure to a traditional requirement. Consider the following examples:

### Example 8.3

Database Management: Novice Level

| Type | Subject | Activity | Qualifiers |
|---|---|---|---|
| Primary | Database | | Level: |
| | Management | | Novice Level |

### Example 8.4

Computer skills and office equipment: basic

| | | | |
|---|---|---|---|
| Type | Subject | Activity | Qualifiers |

| | | |
|---|---|---|
| Primary | Computer skills and | Level: |
| | basic equipment | basic |

Similarly, consider the following header requirement:

### Example 8.5

Years of Experience: 1

| | | | |
|---|---|---|---|
| Type | Subject | Activity | Qualifiers |

| | | |
|---|---|---|
| Primary | Experience | Years: |
| | | 1 |

It is not useful to annotate a year's qualifier when there is no subject for it to qualify. Here, the system can determine that the subject is “Experience,” though it is not particularly meaningful.

Unnecessary Annotations

Information is only meaningful to annotate if it qualifies what a candidate needs to know—if it defines KSAs (knowledge, skills, and abilities) that a candidate needs to have or develop in order to do well in the job, or if it is information about duties/tasks that an individual could learn about or train for. The following examples illustrate phrases that, for the purposes of annotation, can be considered meaningless:

### Example 9.1

Conducts on-site audits per the direction of the CFO

| | | | |
|---|---|---|---|
| Type | Subject | Activity | Qualifiers |

| | | |
|---|---|---|
| Primary | on-site audits | Conducts |

For Example 9.1, it is unimportant that the individual is conducting audits per the direction of the CFO. That phrase contains nothing the individual can train for and learn about, and therefore, it contains no value as an annotation. What is important for the individual to know is that the job requires that they conduct audits. “Per the direction of the CFO” does not qualify the requirement in any meaningful way.

### Example 9.2

Leads cross-functional team members
assigned during the duration of a project

| | | | |
|---|---|---|---|
| Type | Subject | Activity | Qualifiers |

| | | |
|---|---|---|
| Primary | cross-functional | Leads |
| | team members | |

Similarly, for Example 9.2, it is important for the individual to know that this job requires they lead cross-functional team members. There is no additional meaning for the individual to know that these team members were assigned during the duration of a project. Though the system is not annotating these phrases, the system still includes them in the text, as they provide meaning to the algorithm.

On that score, when a sentence includes a meaningful requirement, all text preceding or following the meaningful requirement (but within the sentence) should still be included in text—even unimportant language such as “The individual will . . . . ” This instructs the algorithm as to what language is unimportant, and what language should be annotated. Consider the following sentence:

### Example 9.3

Students interested in this opportunity should
be entering their Junior or Senior year within an
undergraduate program of Engineeering or Business

| | | | |
|---|---|---|---|
| Type | Subject | Activity | Qualifiers |

| | | |
|---|---|---|
| Education | Engineering or | Level: |
| | Business | Junior or Senior |
| | | year within an |
| | | undergraduate |
| | | program |

Here, the system includes all text prior to the actual requirement, which begins at “Junior.” Conversely, there are entire sentences that are meaningless (e.g., sentences that describe the company), or that contain meaningless requirements. Example embodiments of the system would not include them as text, nor annotate anything. The algorithm learns to ignore these entirely meaningless sentences in an indirect way.

Examples of meaningless requirements include de “Enthusiasm,” or “Patience.” Not only are these universal requirements with no real meaning, but also they are not quantifiable—an individual could not demonstrate these KSAs via past experience or credentials.

Last, while they may not appear meaningful, physical requirements are not to be ignored. Requirements such as “sit for long periods” or “heavy lifting” are meaningful, and should be annotated.

Output From An Example Algorithm

This section shows the inputs to the algorithm and the information extracted by the algorithm. Built an Executive Dashboard and Reporting tool in SharePoint by fetching data from multiple internal and external data sources to help Executives monitor and analyze project performance.

REQUIREMENT: PRIMARY: <ACTIVITY: Built [<[build/Create]>]><SUBJECT: Executive Dashboard and Reporting tool in SharePoint [<executive dashboard><tool in sharepoint>]><SUBJECT_QUALIFIER: by fetching data from multiple internal and external data sources [<data><internal and external data sources>]>

REQUIREMENT: SUBORDINATE: <ACTIVITY: help [<[help/Collaborate]>]><SUBJECT: Executives monitor and analyze project performance [<executiyes><project performance>]>

Competency statements extracted from this statement:

Built executive dashboard.

Built tool in SharePoint.

The competency statement is created by combining the activity and the subject. The subject usually references a skill term and the activity describes how the skill is being used. By classifying activities to the Bloom's taxonomy, the system can determine the level of expertise required. Subordinate activities are not considered when constructing competency statements. Subordinate activities are not directly related to the job responsibilities but indicate the goals to be achieved by the primary goals. The words highlighted in red indicate the Bloom's level corresponding to the verbs. Facilitate tax preparation through Auditor inquiries.

REQUIREMENT: PRIMARY: <ACTIVITY: Facilitate [<[facilitate/Collaborate]>]><SUBJECT: tax preparation through Auditor inquiries [<tax preparation><auditor inquiries>]>

Competency statements extracted from this statement:

Facilitate tax preparation.

Facilitate auditor inquiries.

Evaluated records for accuracy of balances, postings, and calculations.

REQUIREMENT: PRIMARY: <ACTIVITY: Evaluated [<[evaluate/Evaluate]>]><SUBJECT: records for accuracy [<records for accuracy>]><SUBJECT_QUALIFIER: of balances, postings, calculations. [<balances><postings><calculations>]>

Competency statements extracted from this statement:

Evaluate records for accuracy.

Proficient in posting to GL; preparing trial balance; detecting discrepancies.

REQUIREMENT: PRIMARY: <ACTIVITY: posting to><LEVEL: Proficient in><SUBJECT: GL [<g1>]>

REQUIREMENT: PRIMARY: <ACTIVITY: preparing><SUBJECT: trial balance [<trial balance>]>

REQUIREMENT: PRIMARY: <ACTIVITY: detecting><SUBJECT: discrepancies [<discrepancies>]>

Job Examples

Ability to react with alertness and skill in any emergency situation, (e.g., cardiac or respiratory arrest, hemorrhage, shock, severe physical trauma, and psychiatric reaction).

REQUIREMENT: PRIMARY: <ACTIVITY: react with><LEVEL: Ability to><SUBJECT: alertness and skill [<alertness><skill>]><SUBJECT_QUALIFIER: in any emergency situation, (e.g., cardiac or respiratory arrest, hemorrhage, shock, severe physical trauma and psychiatric reaction [<emergency situation><e g><cardiac><respiratory arrest><hemorrhage><shock><severe physical trauma><psychiatric reaction>]>

Competency statements extracted from this statement:

React with alertness and skill.

Assess patients' conditions for potential or life-threatening crisis.

Distinguish between normal and abnormal physical findings (from physical assessment and vital sign assessment).

Plan appropriate nursing care.

Notify physician if needed.

REQUIREMENT: PRIMARY: <ACTIVITY: Assess [<[assess/Evaluate]>]><SUBJECT: patients' conditions for potential or life-threatening crisis [<patients' conditions><potential or life-threatening crisis>]>

REQUIREMENT: PRIMARY: <ACTIVITY: Distinguish between [<[distinguish/Analyze]>]><SUBJECT: normal and abnormal physical findings [<normal and abnormal physical findings>]><SUBJECT_QUALIFIER: from physical assessment and vital sign assessment [<physical assessment><vital sign assessment>]>

REQUIREMENT: PRIMARY: <SUBJECT: Plan appropriate nursing care [<plan appropriate nursing care>]>

REQUIREMENT: PRIMARY: <ACTIVITY: Notify><SUBJECT: physician [<physician>]>

Competency statements extracted from this statement:

Assess patients' conditions.

Assess potential or life-threatening crisis.

Distinguish normal and abnormal physical findings.

Notify physician.

Further embodiments can be envisioned to one of ordinary skill in the art after reading this disclosure. In other embodiments, combinations or sub-combinations of the above-disclosed invention can be advantageously made. The example arrangements of components are shown for purposes of illustration and it should be understood that combinations, additions, re-arrangements, and the like are contemplated in alternative embodiments of the present invention. Thus, while the invention has been described with respect to exemplary embodiments, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present.

Operations of processes described herein can be performed in any suitable order unless otherwise indicated herein or otherwise clearly contradicted by context. Processes described herein (or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

### APPENDIX A1

### Example a Inputs

### Primary Responsibilities:

Design, develop, and construct lentivirus vectors to genetically modify CD34+ cells and T lymphocytes—expand the gene-modified cells in culture.
Design and develop cell-based assays to assess the functional characteristics of genetically modified CD34+ cells and T lymphocytes
Prepare all technical reports needed in support of an exploratory project moving to process development
Exercise independent judgment in development of new methods, techniques and evaluation of criteria

Requirements:
BS/MS cell biology, molecular biology immunology or related discipline with 5+ years' experience in a relevant field
Experience in molecular cloning—Experience with viral vector or vaccine production is a plus
Expertise in mammalian cell culture, with specific experience isolating and propagating in vitro culture of human CD34+ cells and human/mouse T lymphocytes
Experience with flow cytometry of primary human cells—cell sorting experience a plus
Strong ability to present data in a variety of team settings and actively participate in the departmental meetings as well as cross-functional area project teams in a fast-paced environment
Excellent oral and written communication skills
Ability to work in a team environment, meet deadlines, and prioritize and balance work from multiple individuals
Independently motivated, detail oriented and good problem solving ability
Excellent organizational skills, sufficient to multi-task in an extremely fast-paced environment with changing priorities
Be ready to embrace the principles of the bluebird bio culture: b colorful, b cooperative, and b yourself

### APPENDIX B1

### Example B Inputs

### Job Description

The Process Engineer will work with our clients to provide engineering support to various areas, including cell culture, manufacturing support equipment, protein recovery and purification and critical utility systems. This engineer will be involved throughout the project lifecycle, including initiation, design, construction, implementation, commissioning, and qualification.

### Essential Duties and Responsibilities

Provide process engineering and project management expertise to our clients in the areas of cell culture, engineering, design and process and/or scale-up
Develop and recommend new process formulas and technologies to achieve cost effectiveness and improved product quality
Establish operating equipment specs and provide recommendation to improve manufacturing techniques
Work on problems of diverse scope in which analysis of data requires evaluation of identifiable factors
Support production through analysis of metrics to provide ways to simplify process and optimize results
Manage system and equipment design and engineering documentation such as PFDs, P&IDs, URSs, Design Specifications, O&M manual development, equipment data sheets, piping isometrics and installation qualifications
Provide process engineering support in for clean water systems, CIP, SIP and pharmaceutical process equipment
Promote cGMP and regulatory compliance into assigned projects
Exercise judgment within generally defined practices and policies in selecting methods and techniques for obtaining solutions

### Desired Skills & Experience

Solid understanding of lean manufacturing concepts, ability to implement continuous improvements
B.S. or M.S. in Engineering (Chemical or Mechanical preferred)
5-7 years' experience in equipment, process or clean utility systems
Knowledge of cGMP requirements and the ability to generate engineering drawings and specifications
Solid understanding of clean room or classified area design/requirements
Proven ability to use creativity and innovation to address urgent and/or complex problems and propose solutions
Effective written and oral communication skills; ability to write, type, express or exchange ideas; ability to convey information/instructions accurately
Proficient knowledge of biopharmaceutical manufacturing, process equipment and supporting utility systems, especially those related to sanitary and sterile operations
Ability to relate with people at all levels within an organization, including diverse cultures
Willingness to travel as needed

What is claimed is:

1. A data mining system comprising:
memory storage for job opening data;
a parser configured to derive, from the job opening data, relevant competencies;
memory storage for job-competency mappings;
memory storage for job candidate data;
a parser configured to derive, from the job candidate data, competencies and competency levels for job candidates;
memory storage for candidate-competency mappings; and
a competency search engine configured to match data in the memory storage for job-competency mappings and memory storage for candidate-competency mappings.

2. The data mining system of claim 1, further comprising a validation engine configured to validate candidate-competency mappings, at least in part, using a testing system to test candidates.

3. The data mining system of claim 1, further comprising a feedback engine configured to output candidate prospects for cases where candidate competency is raised.

4. The data mining system of claim 1, further comprising a job description database, wherein the job description database is configured to store a job description according to a series of competency statements.

5. The data mining system of claim 4, further comprising an extraction engine configured to detect at least one pattern in the series of competency statements, wherein the detected at least one pattern is used to compare job candidate data of a first job candidate and job candidate data of a second candidate.

6. The data mining system of claim 5, wherein the extraction engine is further configured to apply the detected at least one pattern to extract competencies from unseen job descriptions.

7. A computer-implemented method for matching data for candidate competency, comprising:
under the control of one or more computer systems configured with executable instructions,
storing job opening data;
parsing the job opening data for relevant competencies;
storing candidate data;
mapping the job opening data and the candidate data, wherein the mapping includes comparing the job opening data, the relevant competencies, and the candidate data;
deriving competencies and competency levels for the candidate; and
matching data, store in a memory for job-competency mappings and a memory storage for candidate-competency mappings.

8. The computer-implemented method of claim 7, further comprising validating candidate-competency mappings, at least in part, using a testing system to test candidates.

9. The computer-implemented method of claim 7, further comprising providing output related to candidate prospects for cases where candidate competency is raised.

10. The computer-implemented method of claim 7, further comprising a storing a job description according to a series of competency statements.

11. The computer-implemented method of claim 7, further comprising detecting at least one pattern in a series of competency statements, wherein the detected at least one pattern is used to compare the candidate data of a first job candidate and candidate data of a second candidate.

12. The computer-implemented method of claim 7, further comprising applying the detected at least one pattern to extract competencies from unseen job descriptions.

13. A non-transitory computer-readable storage medium having stored thereon executable instructions that, when executed by one or more processors of a computer system, cause the computer system to at least:
receive a request for a competency resource from a requestor;
in response to the received request, create a markup document that includes a list of relevant competencies based, at least in part, on job opening data;
obtain job candidate data, including competencies and competency levels for a job candidate;
map the obtained job candidate data and the list of relevant competencies;
create a competency resource document based on the mapping; and
provide at least one competency resource document to the requestor.

14. The non-transitory computer-readable storage medium of claim 13, wherein the instructions further comprise instructions that, when executed by the one or more processors, cause the computer system to validate candidate-competency mappings, at least in part, using a testing system to test candidates.

15. The non-transitory computer-readable storage medium of claim 13, wherein the instructions further comprise instructions that, when executed by the one or more processors, cause the computer system to output candidate prospects for cases where candidate competency is raised.

16. The non-transitory computer-readable storage medium of claim 13, wherein the instructions further comprise instructions that, when executed by the one or more processors, cause the computer system to store a job description according to a series of competency statements.

17. The non-transitory computer-readable storage medium of claim 13, wherein the instructions further comprise instructions that, when executed by the one or more processors, cause the computer system to detect at least one pattern in a series of competency statements, wherein the detected at least one pattern is used to compare candidate data of a first candidate and candidate data of a second candidate.

18. The non-transitory computer-readable storage medium of claim 13, wherein the instructions further comprise instructions that, when executed by the one or more processors, cause the computer system to apply the detected at least one pattern to extract competencies from unseen job descriptions.

19. The non-transitory computer-readable storage medium of claim 13, wherein the instructions further comprise instructions that, when executed by the one or more processors, cause the computer system to generate one or more rules for configuring a structured document for assessing an outcome of a comparison between the job candidate and the job opening data.

20. The non-transitory computer-readable storage medium of claim 13, wherein the instructions further comprise instructions that, when executed by the one or more processors, cause the computer system to identify a subject and subject qualifiers to be used to identify the job candidate most closely related to the job opening data.
